(19) United States
(12) Patent Application Publication
(10) Pub. No.: US 2015/0154000 A1
(43) Pub. Date: Jun. 4, 2015

(54) INFORMATION PROCESSING DEVICE, INFORMATION PROCESSING METHOD, AND PROGRAM

(71) Applicant: Sony Corporation, Tokyo (JP)

(72) Inventors: Miwa Ichikawa, Tokyo (JP); Ritsuko Kano, Tokyo (JP); Tsuyoshi Ishikawa, Kanagawa (JP); Koji Ihara, Chiba (JP); Tomoki Uehara, Tokyo (JP); Koichi Kawasaki, Tokyo (JP); Takuya Namae, Kanagawa (JP); Ryouhei Yasuda, Kanagawa (JP)

(73) Assignee: Sony Corporation, Tokyo (JP)

(21) Appl. No.: 14/408,667

(22) PCT Filed: Jun. 5, 2013
(86) PCT No.: PCT/JP2013/065565

§ 371 Date: Dec. 17, 2014

(30) Foreign Application Priority Data
Jun. 26, 2012 (JP) 2012-143159

(51) Int. Cl. G06F 3/16; G05B 15/02

(52) U.S. Cl. CPC G06F 3/165; G05B 15/02

(57) ABSTRACT

There is provided an information processing device including a user interface unit which receives a user's operation, a playback control unit which performs an editing process on content playback control information, depending on the user's operation received by the user interface unit, and controls an operation of playing back content based on the content playback control information, and a display unit which displays a played-back image of the content.

### TECHNICAL FIELD

The present technology relates to information processing devices, information processing methods, and programs. More specifically, the present technology allows for easy adjustment of an operation of playing back content.

### BACKGROUND ART

Conventionally, a device which synthesizes audio from accumulated text data, and reads text of the text data aloud, is commonly used. For example, Patent Literature 1 states that when text is read aloud, emphasized characters (characters with a different attribute, such as enlarged characters, bold characters, characters in parentheses, etc.) in text formed in a written document can be read aloud in a different manner (different volume, different speed, etc.) from the normal manner.

### CITATION LIST

### Patent Literature

Patent Literature 1: JP H9-16190A

### SUMMARY OF INVENTION

### Technical Problem

Incidentally, in Patent Literature 1, in order to read text aloud in a different manner from the normal manner, the way of reading characters in text to be read aloud is determined based on the result of text analysis and an instruction to change reading aloud of characters having a non-normal attribute value in accordance with the character attribute. Also, an audio waveform is synthesized with reference to an audio data file based on the determined way of reading characters. Therefore, an increased number of character attributes are required in order to finely adjust the operation of playing back audio data, i.e., it is not easy to achieve fine adjustment.

Therefore, it is an object of the present technology to provide an information processing device, information processing method, and program which allow for easy adjustment of the operation of playing back content.

### Solution to Problem

According to a first embodiment of the present technology, there is provided an information processing device including a user interface unit which receives a user's operation, a playback control unit which performs an editing process on content playback control information, depending on the user's operation received by the user interface unit, and controls an operation of playing back content based on the content playback control information, and a display unit which displays a played-back image of the content.

In the present technology, an editing process is performed on the content playback control information, depending on the user's operation received by the user interface unit, and based on the content playback control information, for example, an operation of playing back display content and audio content associated with the display content is controlled. In the editing process, an attribute of content is changed. Also, in changing of an attribute, an attribute of display content is changed in connection with a change in a playback operation of audio content, and a playback operation of audio content is changed in connection with a change in an attribute of display content. The editing process includes: an editing process of changing the playback speed of content in an editing range; an editing range of changing the volume of audio content in an editing range; an editing process of performing a fading operation on audio content in an editing range; an editing process of changing the language of content in an editing range; an editing process of changing audio in an editing range; an editing process of cancelling playback of content in an editing range; an editing process of changing the time between audio data in audio content; an editing process of performing a copying or cutting operation on content in an editing range; an editing process of performing a pasting operation of inserting content at a specified location; etc. These editing processes are performed on the content playback control information, depending on the user's operation. Also, in the editing process, difference information indicating the details of the editing process may be produced.

According to a second embodiment of the present technology, there is provided an information processing method comprising the steps of receiving a user's operation, performing an editing process on content playback control information, depending on the user's operation, and controlling an operation of playing back content based on the content playback control information.

According to a third embodiment of the present technology, there is provided a program for causing a computer to control playback of content, the program causing the computer to execute the procedures of receiving a user's operation, performing the editing process on content playback control information, depending on the user's operation, and controlling playback of content based on the content playback control information.

Note that the program of the present technology may be provided in a storage medium or communication medium which provides the program to a general-purpose computer which can execute various program codes, in a computer readable format. The storage medium includes, for example, an optical disk, magneto-optical disk, semiconductor memory, etc. The communication medium includes, for example, a network, etc. By providing such a program in a computer readable format, a process corresponding to the program is carried out by the computer.

### Advantageous Effects of Invention

According to the present technology, an editing process is performed on content playback control information, depending on the user's operation which has been received. A content playback operation is controlled based on the content playback control information so that a played-back image of content is displayed on a display unit. Therefore, for example, when an operation of playing back content in which display content is associated with audio content is adjusted, the playback operations of the display content and the audio content can be adjusted together without performing an editing process on each piece of content separately. Therefore, the content playback operation can be easily adjusted. Note that advantages described herein are merely illustrative and not intended to be limiting. Also, additional advantages may be provided.

### BRIEF DESCRIPTION OF DRAWINGS

FIG. 1 is a diagram illustrating a configuration of an information processing device.

FIG. 2 is a sequence diagram showing an operation which is performed when content has been selected.

FIG. 3 is a diagram illustrating a portion of the details of an XHTML file.

FIG. 4 is a diagram illustrating a portion of the details of a CSS file.

FIG. 5 is a diagram illustrating a portion of the details of an SMIL file.

FIG. 6 is a sequence diagram showing a content playback operation.

FIG. 7 is a sequence diagram showing an editing operation.

FIG. 8 is a diagram illustrating a change corresponding to an editing operation.

FIG. 9 is a sequence diagram showing a playback operation after editing.

FIG. 10 is a flowchart illustrating a playback control operation corresponding to an editing operation.

FIG. 11 is a diagram illustrating menu display showing items to be edited.

FIG. 12 is a flowchart illustrating an editing operation which is performed when the playback speed of audio is changed.

FIG. 13 is a diagram illustrating an operation which is performed when the playback speed of audio is changed.

FIG. 14 is a flowchart illustrating an editing operation which is performed when the volume is changed.

FIG. 15 is a diagram illustrating an operation which is performed when the volume is changed.

FIG. 16 is a flowchart illustrating an editing operation which is performed when fading is performed.

FIG. 17 is a diagram illustrating an operation which is performed when fading is performed.

FIG. 18 is a diagram illustrating a case where a fading-out operation is performed at a tail portion of content, and a fading-in operation is performed at a head portion of content which is next played back.

FIG. 19 is a flowchart illustrating an editing operation which is performed when copying and pasting are performed.

FIG. 20 is a diagram illustrating an operation which is performed when copying and pasting are performed.

FIG. 21 is a diagram illustrating an operation which is performed when cutting is performed.

FIG. 22 is a flowchart illustrating an editing operation which is performed when languages are changed.

FIG. 23 is a diagram illustrating an operation which is performed when languages are changed.

FIG. 24 is a flowchart illustrating an editing operation which is performed when audio is changed.

FIG. 25 is a diagram illustrating an operation which is performed when audio is changed.

FIG. 26 is a flowchart illustrating an editing operation which is performed when muting is performed.

FIG. 27 is a diagram illustrating an operation which is performed when a part of audio is muted.

FIG. 28 is a flowchart illustrating an editing operation which is performed when the time between audio data is changed.

FIG. 29 is a diagram illustrating an operation of changing the time of audio data.

### DESCRIPTION OF EMBODIMENTS

Hereinafter, embodiments for carrying out the present technology will be described. Note that the description will be given in the following order.

1. Configuration of Information Processing Device

2. Operation of Information Processing Device

3. Editing Operation
3-1. Changing Speed
3-2. Changing Volume
3-3. Fading Operation
3-4. Coping, Pasting, and Cutting Operations
3-5. Changing Languages
3-6. Changing Speech
3-7. Operation of Muting Part of Speech
3-8. Changing Time between Speech Data

<1. Configuration of Information Processing Device>

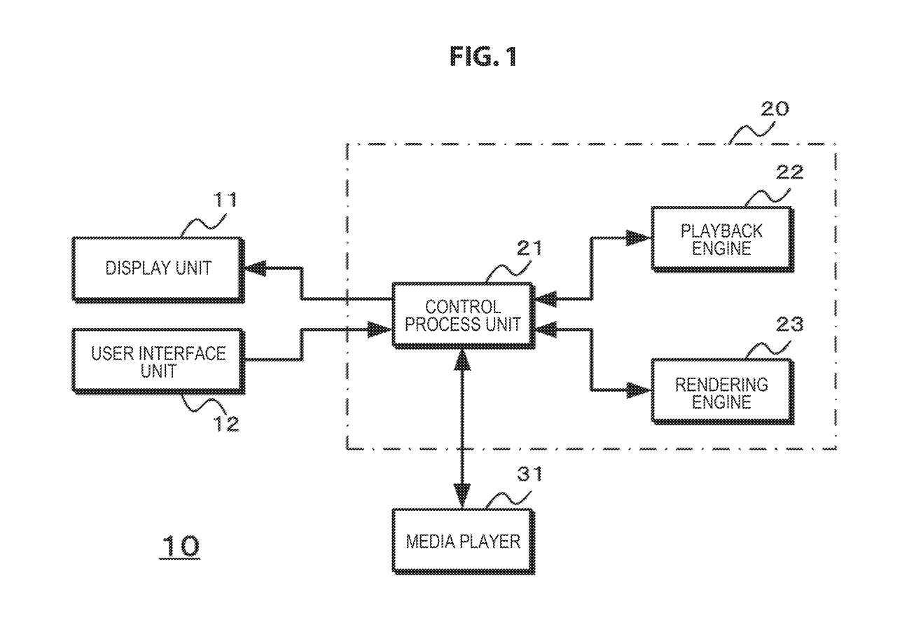

FIG. 1 illustrates a configuration of an information processing device of the present technology. The information processing device 10 includes a display unit 11, a user interface unit 12, a playback control unit 20, and a media player 31. Also, the playback control unit 20 includes a control process unit 21, a playback engine 22, and a rendering engine 23.

The display unit 11 displays images, characters, etc., of display content, a menu for changing operations, settings, etc., of the information processing device 10, and the like.

The user interface unit 12 receives the user's operation, and generates and supplies an operation signal corresponding to the user's operation to the control process unit 21. The user interface unit 12, which, for example, includes a touch panel, is provided on a screen of the display unit 11 to allow for a GUI (Graphical User Interface) operation.

The control process unit 21 of the playback control unit 20 causes the display unit 11 to display a menu for selecting an operation or function of the information processing device 10 and determining various settings, etc., and the like. Also, the control process unit 21 selects content to be played back and controls playback of the selected content based on the operation signal from the user interface unit 12. For example, the control process unit 21 causes the playback engine 22 to control a layout of images, characters, and audio on the time axis based on content playback control information. Also, the control process unit 21 causes the rendering engine 23 to calculate an arrangement of images, characters, etc., based on the content playback control information. Moreover, the control process unit 21 causes the media player 31 to played-back images, characters, audio, etc., based on the layout on the time axis determined by the playback engine 22 and the arrangement calculated by the rendering engine 23.

The playback engine 22 controls timing of playback of content, such as images, characters, audio, etc. For example, the playback engine 22 uses the SMIL engine, which controls playback of content which is based on the Synchronized Multimedia Integration Language (SMIL), etc. Note that SMIL, which is defined by the World Wide Web Consortium (W3C), is a multimedia control language for controlling the layout of content on the time axis. When the SMIL engine is used as the playback engine 22, SMIL data is used as the content playback control information.

The rendering engine 23 calculates an arrangement of images, characters, etc., to be displayed on the screen, and the like. The rendering engine 23, which is, for example, Webkit, etc., interprets data of CSS (Cascading Style Sheets), data of styles, etc., in HTML (HyperText Markup Language) or XHTML (Extensible HyperText Markup Language), etc., to calculate an arrangement of images and characters, etc. Specifically, data of CSS (Cascading Style Sheets), etc., is used as the content playback control information.

Also, the playback control unit 20 performs an editing process on the content playback control information based on the user's operation received by the user interface unit 12 so that the content playback operation corresponds to the user's operation. Also, the playback control unit 20 controls the content playback operation based on the content playback control information. The editing process of the content playback control information may be performed by the control process unit 21 or by the playback engine 22 and the rendering engine 23.

The media player 31 plays back an image or audio content file, and for example, displays the played-back image on the screen of the display unit 11. Also, the media player 31 outputs an audio signal of played-back audio.

Note that content played back by the information processing device 10 is, for example, in the EPUB format, which is a file format standard for electronic books. Also, content to be played back is not limited to content in the EPUB format, and may be content which is produced by users, etc.

<2. Operation of Information Processing Device>

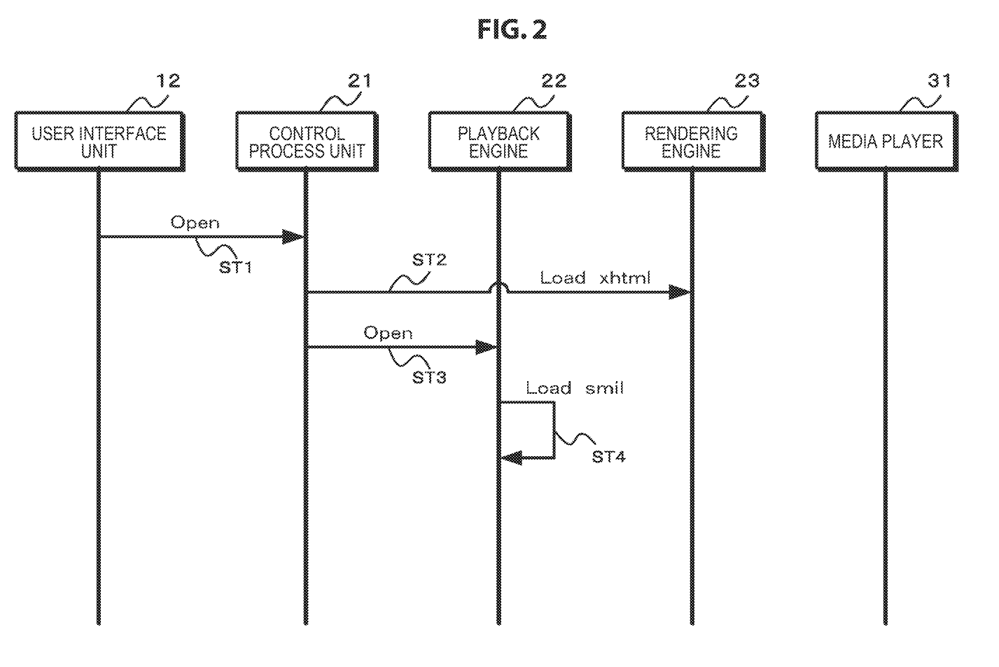

Next, an operation of the information processing device 10 will be described. FIG. 2 is a sequence diagram showing an operation which is performed when the user has selected content. Note that content include display content and audio content associated with the display content.

The user interface unit 12 supplies an operation signal to the control process unit 21, depending on the user's operation which has been performed to open a content file (ST1).

Based on the operation signal from the user interface unit 12, the control process unit 21 determines content which the user desires to open, and causes the rendering engine 23 to obtain, foe example, data of an XHTML file contained in the content file (ST2).

Also, the control process unit 21 instructs the playback engine 22 to open, for example, an SMIL file contained in the content file (ST3). The playback engine 22 obtains data of the SMIL file indicated by the control process unit 21 (ST4).

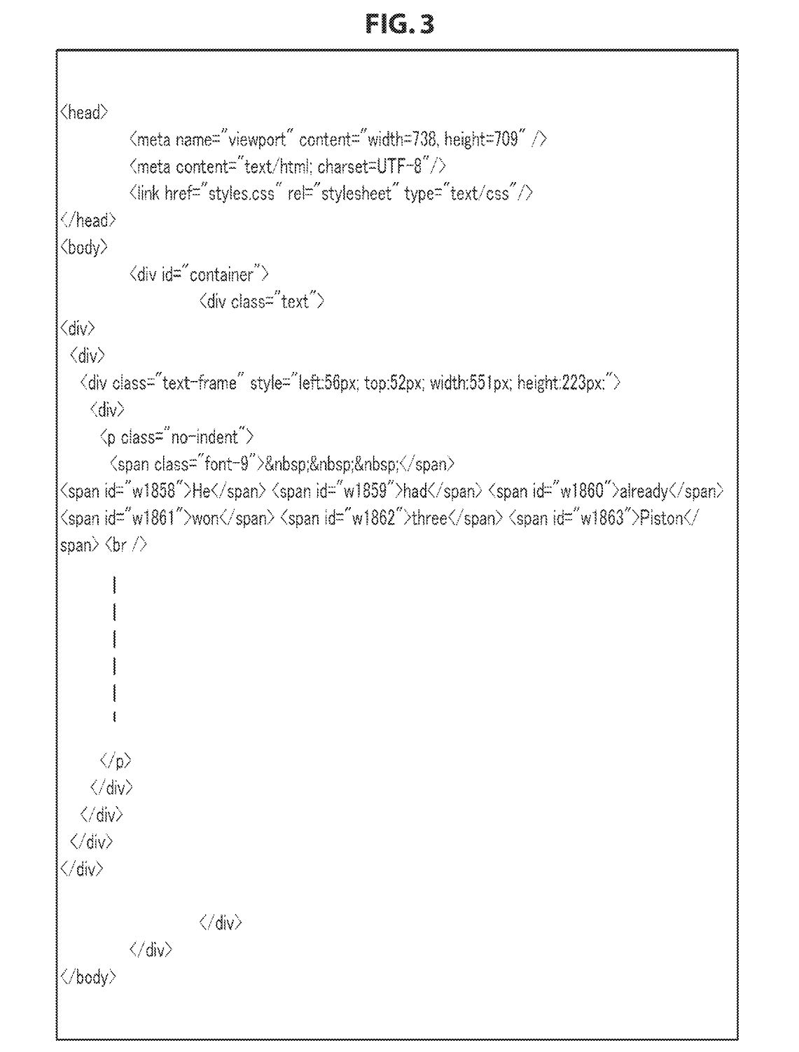

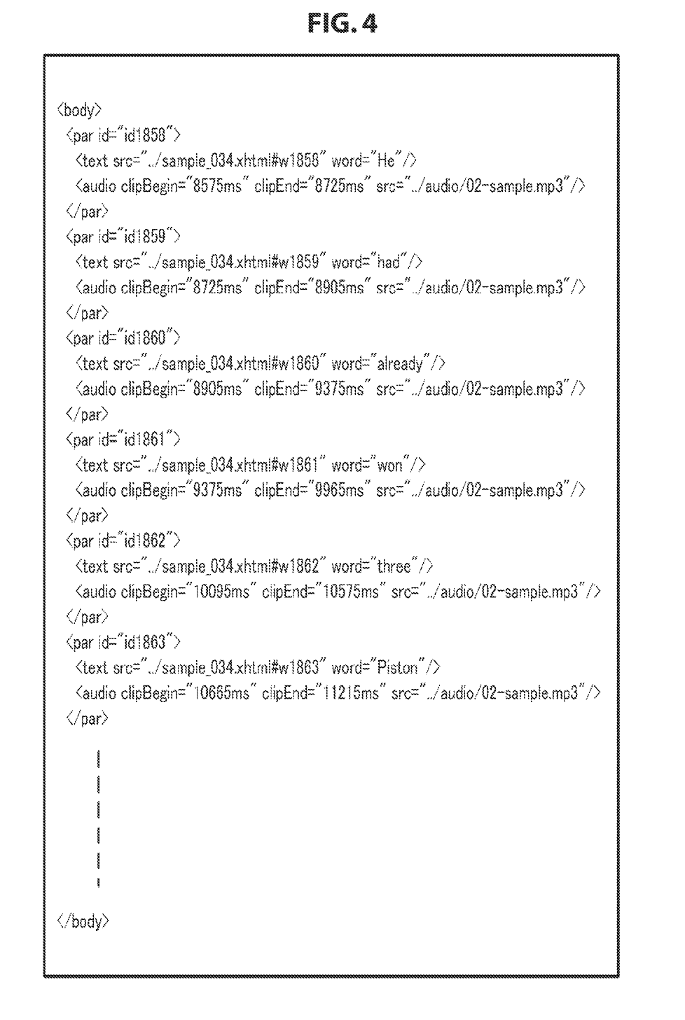

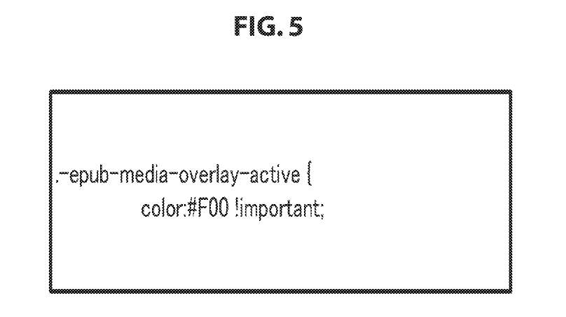

FIG. 3 shows a portion of the details of an XHTML file. In the XHTML file (sample_{—}034.xhtml), for example, a related CSS file “styles.css,” the style of a frame which displays characters, characters which are displayed, etc., are shown. FIG. 4 illustrates a portion of the details of the CSS file “styles.css” related to the XHTML file of FIG. 3. In the CSS file of FIG. 4, it is shown that the color of characters is set to red. FIG. 5 illustrates a portion of the details of an SMIL file for controlling playback of audio which reads aloud characters of the XHTML file of FIG. 3. For example, it is shown that, in the read-aloud audio file (02-sample.mp3), audio from a time position “8575 ms” to “8725 ms” of audio data corresponds to characters “He” of an id name “w1858” in the XHTML file (sample_{—}034.xhtml). Also, it is shown that audio from a time position “8725 ms” to “8905 ms” of audio data corresponds to characters “had” of an id name “w1859.”

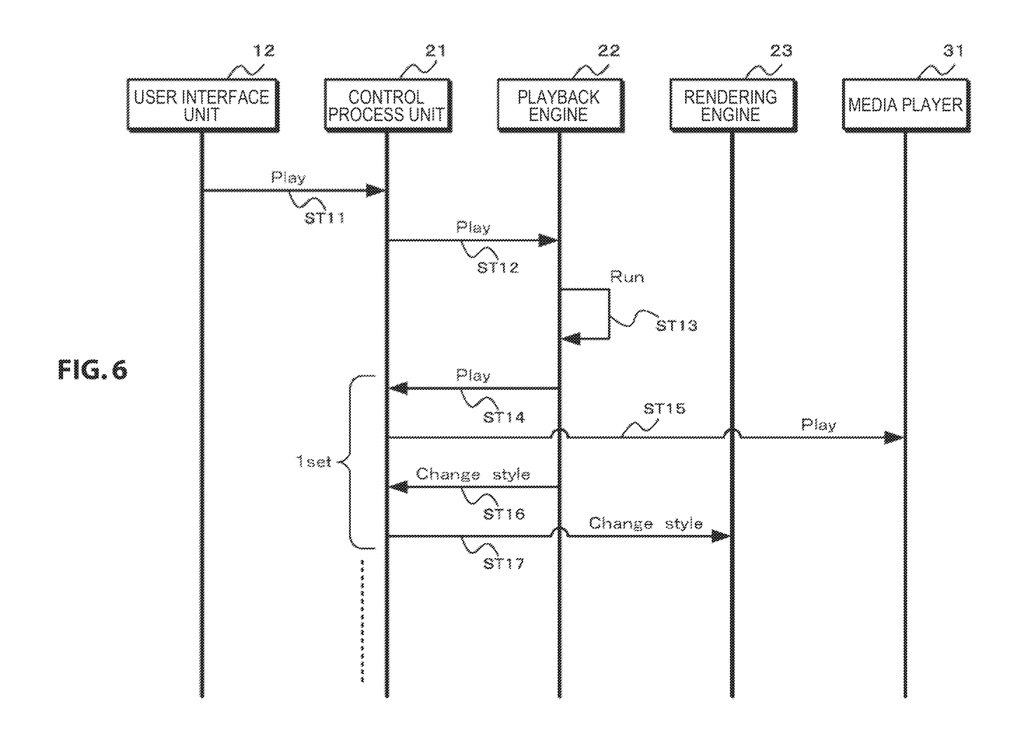

FIG. 6 is a sequence diagram showing a selected content playback operation. The user interface unit 12 supplies an operation signal to the control process unit 21, depending on the user's operation for playing back a content file (ST11).

The control process unit 21 causes the playback engine 22 to start a playback control operation in response to a content file playback start operation based on the operation signal from the user interface unit 12 (ST12).

The playback engine 22 starts a playback control operation based on the details of the SMIL file (ST3). Also, the playback engine 22 instructs the control process unit 21 to play back read-aloud audio based on the details of the SMIL file (ST14). The control process unit 21 controls the media player 31 based on the instruction from the playback engine 22 so that the media player 31 outputs the specified read-aloud audio (ST15).

Also, if the SMIL file indicates that the attribute, layout, etc., of characters are to be changed in connection with playback of the read-aloud audio, the playback engine 22 instructs the control process unit 21 to change styles (ST16).

Based on the instruction to change styles from the playback engine 22, the control process unit 21 causes the rendering engine 23 to change styles (ST17).

By performing the above process, displayed characters can be read aloud, for example. Also, the attribute of displayed characters, etc., may be changed so that a portion which is being read aloud, a portion which has already been read aloud, etc., can be displayed in a distinguishable manner.

Next, an editing operation of changing the playback speed and volume of audio, etc., will be described. As described above, the information processing device 10 controls the layout of content on the time axis based on an SMIL file. Also, the information processing device 10 controls the arrangement, etc., of images, characters, etc., based on a CSS file. Therefore, by updating the content playback control information, such as an SMIL file, a CSS file user, etc., based on the user's editing operation, the information processing device 10 can perform a playback operation corresponding to the result of the editing. For example, the playback control unit 20 of the information processing device 10 performs an editing process of changing the attribute of display content based on a change in the audio content playback operation, and changing the audio content playback operation in connection with a change in the attribute of the display content, on the content playback control information.

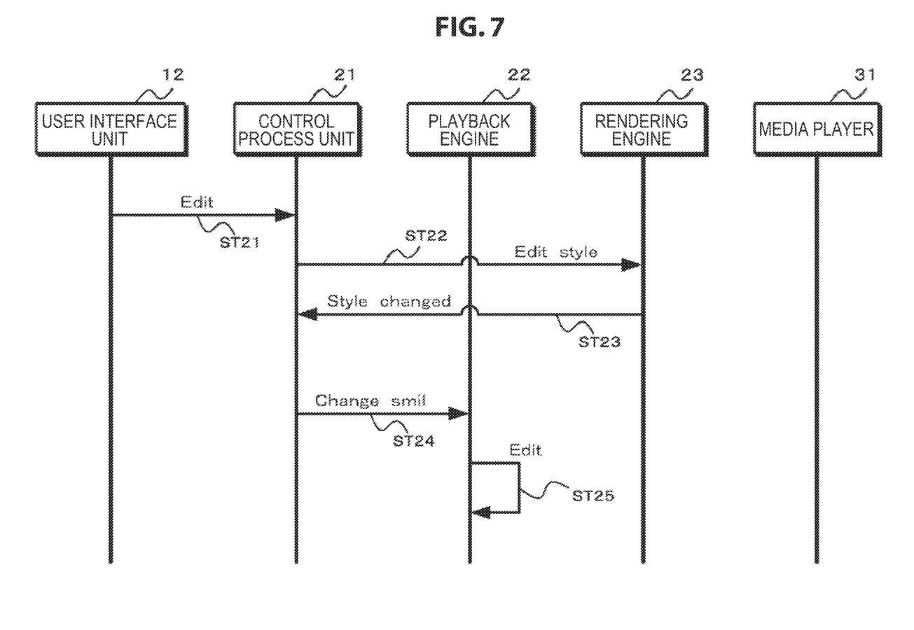

FIG. 7 is a sequence diagram of the editing operation. The user interface unit 12 supplies an operation signal to the control process unit 21, depending on the user's editing operation (ST21).

If the operation signal from the user interface unit 12 indicates that the editing operation includes changing of the layout, the control process unit 21 causes the rendering engine 23 to make a change corresponding to the editing operation (ST22). The rendering engine 23 changes the style attribute at a corresponding portion in the XHTML file or the style specification in the CSS file, etc., depending on the editing operation, and notifies the control process unit 21 that the changing corresponding to the editing operation has been completed (ST23).

Also, if the operation signal from the user interface unit 12 indicates that the editing operation includes changing of the playback operation, the control process unit 21 causes the playback engine 22 to make a change corresponding to the editing operation (ST24). The playback engine 22 changes the attribute at a corresponding portion in the SMIL file, etc., depending on the editing operation (ST25).

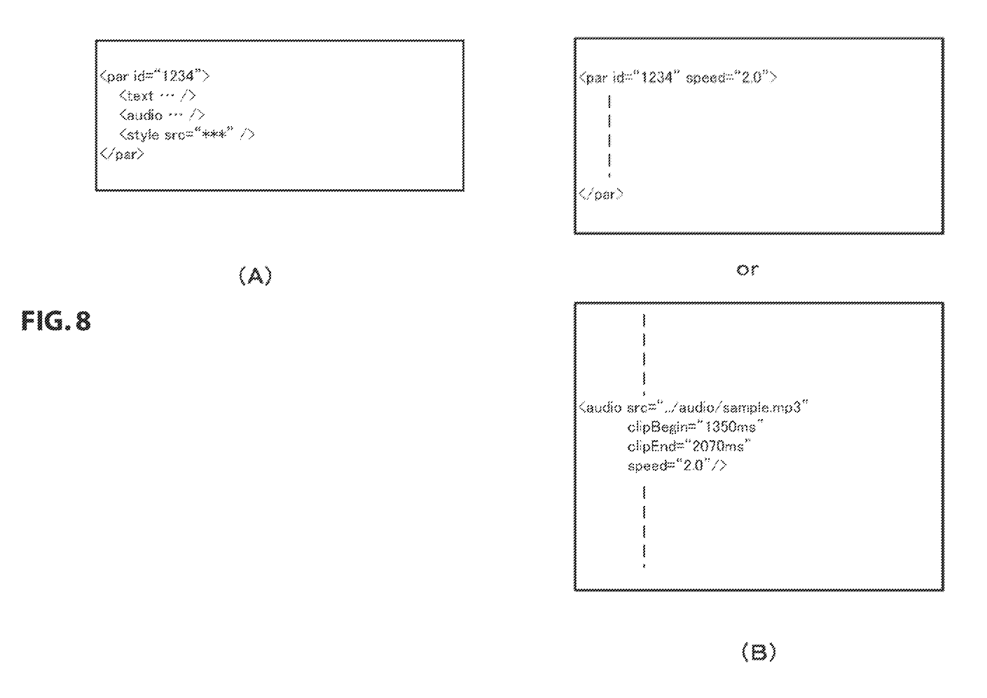

FIG. 8 illustrates a change corresponding to an editing operation. FIG. 8(A) illustrates a style attribute which is added to a CSS file, depending on the editing operation. For example, the rendering engine 23 sets a style attribute for content having an id name “1234.” Note that, in figures, for example, “***” indicates a description portion related to a CSS file name or style which is referred to.

Also, FIG. 8(B) illustrates a style attribute which is added to an SMIL file, depending on an editing operation. For example, the playback engine 22 adds the attribute ‘Speed “2.0”’ to a tag for simultaneously playing back the content having the id name “1234” to double the playback speed. Also, the playback engine 22 may add the attribute ‘Speed “2.0”’ indicating playback speed to the audio tag to double the playback speed.

The information processing device 10 updates a content file by adding a change corresponding to an editing operation to the content file. Also, the information processing device 10 may generate difference information indicating details of an editing process, and manage the difference information as another file (hereinafter referred to as a “difference information file”). When the difference information is managed as another file, a content file before editing can be held. Also, a user who shares a content file before editing can simply reproduce conditions of editing which has been performed by another user, by obtaining only the difference information.

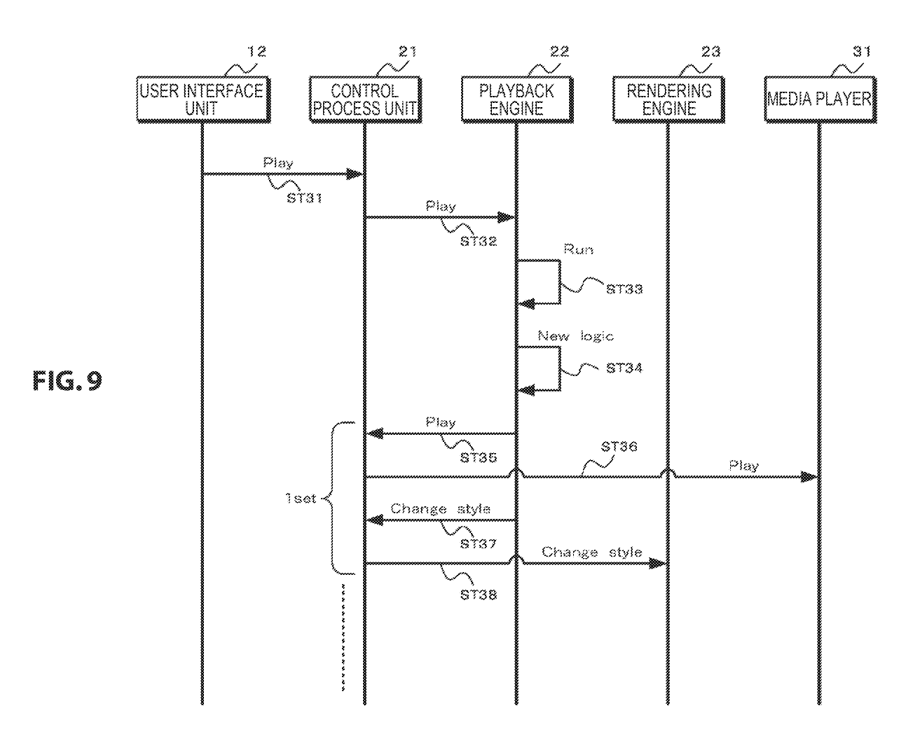

FIG. 9 is a sequence diagram showing a playback operation which is performed after editing. The user interface unit 12 supplies an operation signal to the control process unit 21, depending on the user's operation of playing back a content file (ST31).

The control process unit 21 causes the playback engine 22 to start a playback control operation in response to the content file playback start operation based on the operation signal from the user interface unit 12 (ST32).

The playback engine 22 starts a playback control operation based on details of an SMIL file (ST33). Moreover, if the playback operation has been edited, the playback engine 22 performs a new playback control operation corresponding to the editing operation (ST34).

Based on the details of the SMIL file, the playback engine 22 instructs the control process unit 21 to play back read-aloud audio (ST35). The control process unit 21 controls the media player 31 based on the instruction from the playback engine 22 so that the media player 31 outputs the specified read-aloud audio (ST36).

Also, when the SMIL file indicates that the attribute, layout, etc., of characters are to be changed in connection with playback of the read-aloud audio, the playback engine 22 instructs the control process unit 21 to change styles (ST37).

The control process unit 21 causes the rendering engine 23 to change styles based on the style changing instruction from the playback engine 22 (ST38).

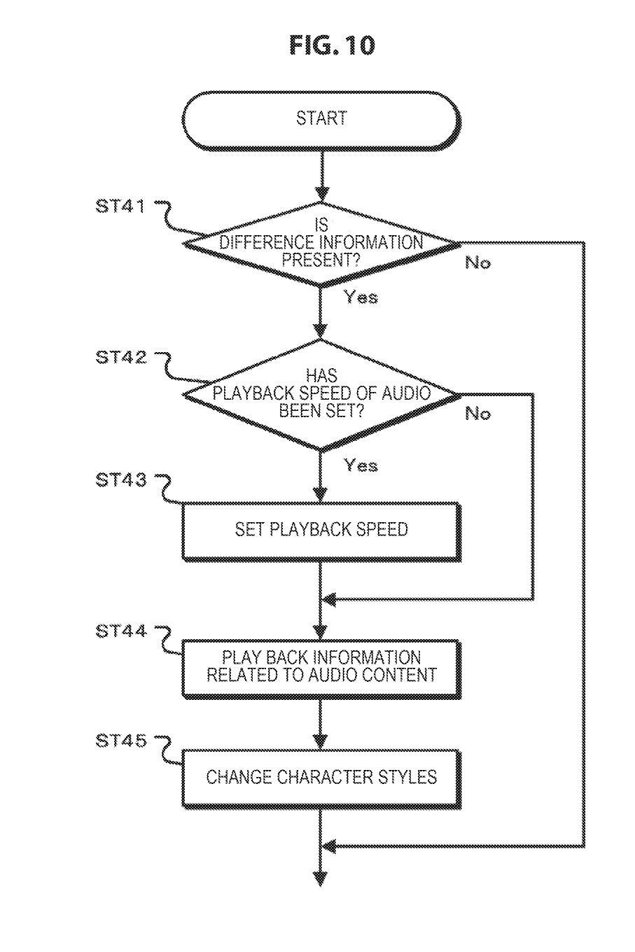

FIG. 10 is a flowchart illustrating a new playback control operation corresponding to an editing operation. Note that FIG. 10 shows a case where details of the editing process are managed as a difference information file.

In step ST41, the playback engine 22 determines whether or not difference information is present. If difference information is present, the playback engine 22 proceeds to step ST42. If difference information is absent, the playback engine 22 ends the process of FIG. 10, and performs playback of read-aloud audio.

In step ST42, the playback engine 22 determines whether or not the audio playback speed has been set. For example, if the attribute “Speed” has been set in the difference information as described with reference to FIG. 8(B), the playback engine 22 proceeds to step ST43. Also, if the audio playback speed has not been set, the playback engine 22 proceeds to step ST44.

In step ST43, the playback engine 22 sets the playback speed of the media player 31. The playback engine 22 controls the playback operation of the media player 31 so that the media player 31 can, for example, play back audio at speed indicated by the attribute “Speed,” and proceeds to step ST44.

In step ST44, the playback engine 22 plays back information related to the audio content. The playback engine 22 causes the media player 31 to play back the information related to the audio content, thereby allowing the media player 31 to correctly play back the audio content, and proceeds to step ST45. Note that the information related to audio content includes information, such as a sampling rate, a bit rate, the number of channels, etc., of audio.

In step ST45, the playback engine 22 changes styles of characters. If a style attribute is set in the difference information as described in FIG. 8(A), the playback engine 22 instructs the rendering engine 23 to change styles.

By performing the above process, displayed characters can be read aloud, for example. Also, the attribute, etc., of displayed characters may be changed so that a portion which is being read aloud, a portion which has already been read aloud, etc., can be displayed in a distinguishable manner. Moreover, audio can be played back at speed corresponding to an editing operation, or characters can be displayed with an attribute corresponding to an editing operation, etc.

<3. Editing Operation>

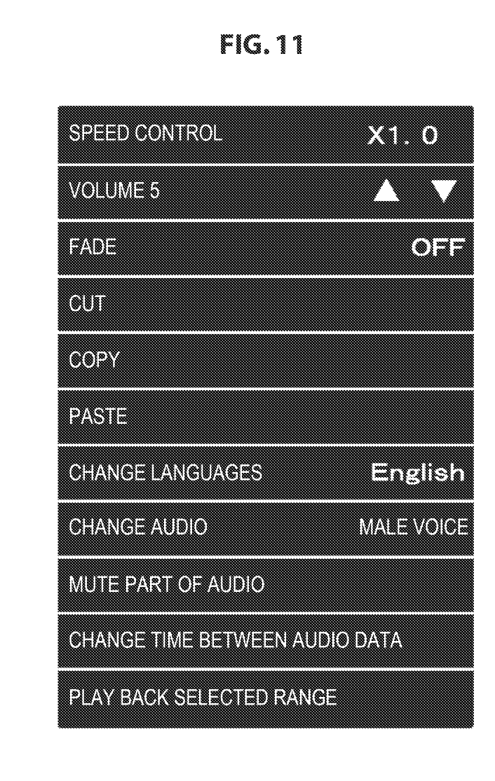

Next, a specific example of the user's editing operation will be described. The information processing device 10 displays a menu which shows items to be edited on the screen of the display unit 11, and performs an editing process corresponding to the user's operation for an item to be edited which has been selected by the user. FIG. 11 illustrates a menu display showing items to be edited. In the menu display, for example, items include “speed control,” “volume,” “fade,” “cut,” “copy,” “paste,” “change languages,” “change audio,” “mute part of audio,” “change time between audio data,” and “play back selected range.”

The item “speed control” is selected in order to change the playback speed of audio. The item “volume” is selected in order to change the volume. The item “fade” is selected in order to perform a fading-in/fading-out operation on audio. The items “cut,” “copy,” and “paste” are selected in order to cut, copy, and paste characters or audio. The item “change languages” is selected in order to change languages of characters or audio. The item “change audio” is selected in order to change the pronunciation of the user's nation, the sex of a person who pronounces. The item “mute part of audio” is selected in order to mute a part of audio. The item “change time between audio data” is selected in order to adjust a time interval between documents or between words. The item “play back selected range” is selected in order to confirm the result of editing. An operation which is performed when each item is selected will now be described.

[3-1. Changing Speed]

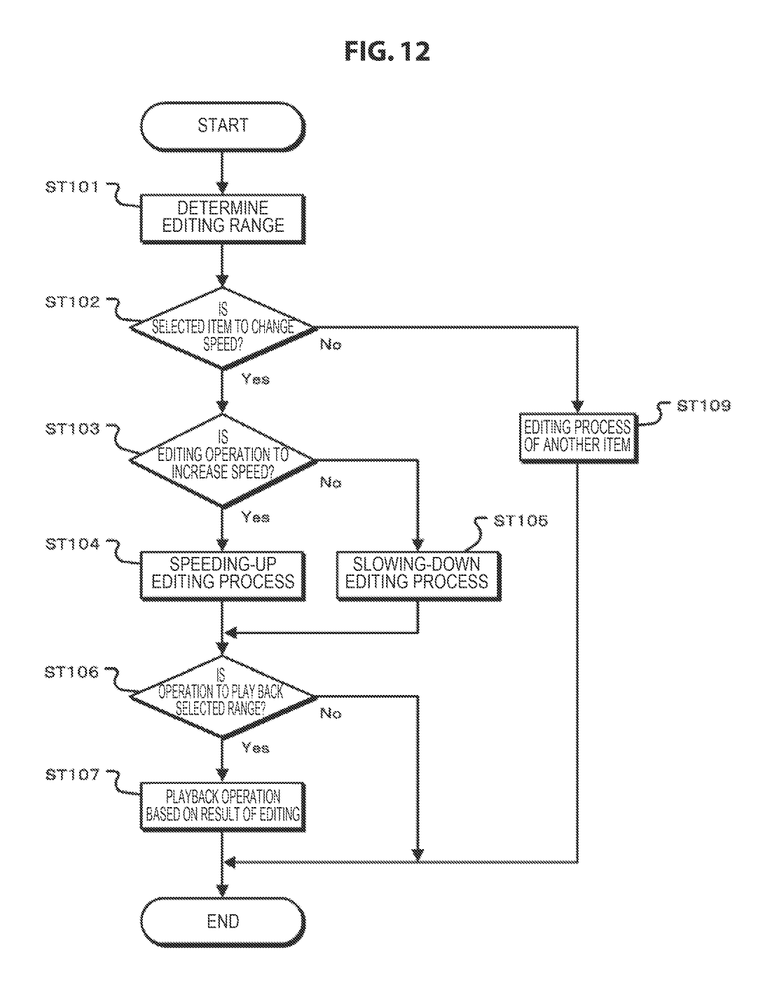

FIG. 12 is a flowchart illustrating an editing operation which is performed when the playback speed of audio is changed in the information processing device 10. In step ST101, the information processing device 10 determines an editing range selected by the user's operation, and proceeds to step ST102.

In step ST102, the information processing device 10 determines whether or not the selected item is to change speed. The information processing device 10, when determining that an operation of selecting the item “speed control” has been performed on the user interface unit 12, determines that the editing operation is to change speed, and proceeds to step ST103. Also, the information processing device 10, when determining that an operation of selecting an item different from the item “speed control” has been performed, determines that the editing operation is not to change speed, and proceeds to step ST109.

In step ST103, the information processing device 10 determines whether or not the user's editing operation is to increase the speed. The information processing device 10, when determining that an operation of increasing the playback speed has been performed on the user interface unit 12, proceeds to step ST104, and when determining that an operation of decreasing the playback speed has been performed, proceeds to step ST105. For example, the information processing device 10 determines that an operation of increasing the playback speed has been performed if a pinch-close operation has been performed on the user interface unit 12, and determines that an operation of decreasing the playback speed has been performed if a pinch-open operation has been performed. Also, the information processing device 10 may display a spinner to allow for an operation of increasing or decreasing the playback speed, depending on the user's operation performed on the spinner.

In step ST104, the information processing device 10 performs an editing process of increasing the speed. The information processing device 10 changes an attribute indicating the playback speed to increase the playback speed, and proceeds to step ST106. Also, in step ST105, the information processing device 10 performs a slowing-down editing process. The information processing device 10 changes the attribute indicating the playback speed to decrease the playback speed, and proceeds to step ST106. Note that the information processing device 10 adds a change corresponding to an editing operation to a content file, or a change corresponding to an editing operation to a difference information file.

In step ST106, the information processing device 10 determines whether or not the user's operation is to play back the selected range. If the user's operation performed after the operation of changing the playback speed is to select the item “play back selected range,” the information processing device 10 proceeds to step ST107. Otherwise, the information processing device 10 ends the editing operation of changing the playback speed.

In step ST107, the information processing device 10 performs a playback operation based on the result of the editing. Specifically, the information processing device 10 plays back the content after the editing process performed in step ST104 or step ST105, and ends the editing operation of changing the playback speed.

The information processing device 10, when proceeding from step ST102 to step ST109, performs an editing operation for another selected item.

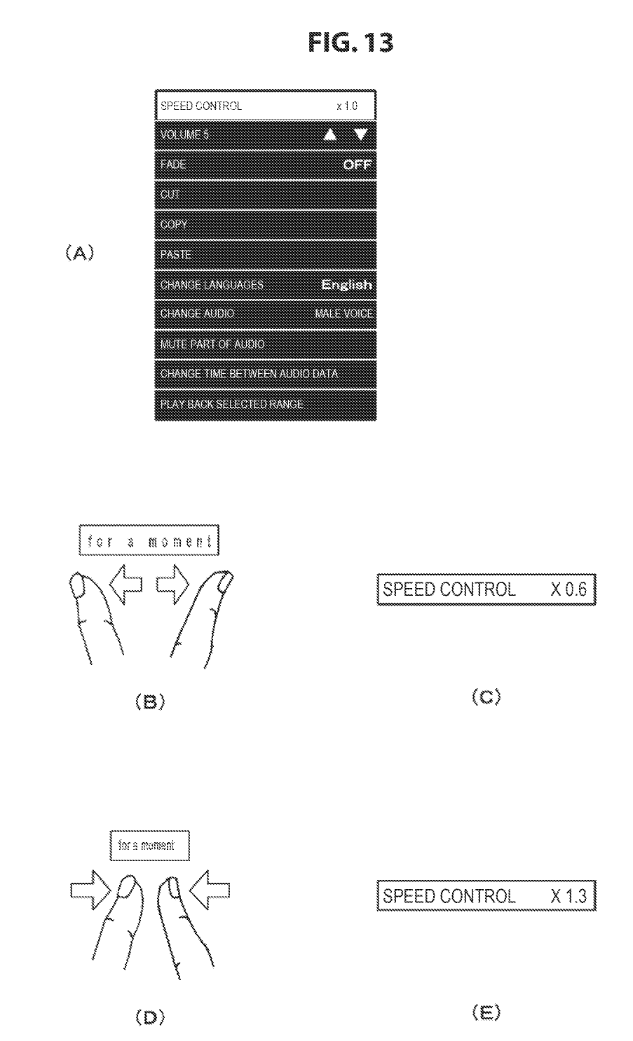

FIG. 13 illustrates an operation which is performed when the playback speed of audio is changed. As shown in FIG. 13(A), the information processing device 10, when the item “speed control” has been selected (in the figure, the selected item is indicated by reverse display), changes the playback speed, depending on the user's operation. For example, as shown in FIG. 13(B), the information processing device 10, when a pinch-open operation has been performed on an editing range, changes the attribute indicating the playback speed to decrease the playback speed. Also, as shown in FIG. 13(C), the information processing device 10 changes a playback speed display shown in the item “speed control.” Also, as shown in FIG. 13(D), the information processing device 10, when a pinch-close operation has been performed on an editing range, changes the attribute indicating the playback speed to increase the playback speed. As shown in FIG. 13(E), the information processing device 10 changes the playback speed display shown in the item “speed control.”

Therefore, by using the information processing device 10 of the present technology, the user can simply and easily change the playback speed of a desired portion.

[3-2. Changing Volume]

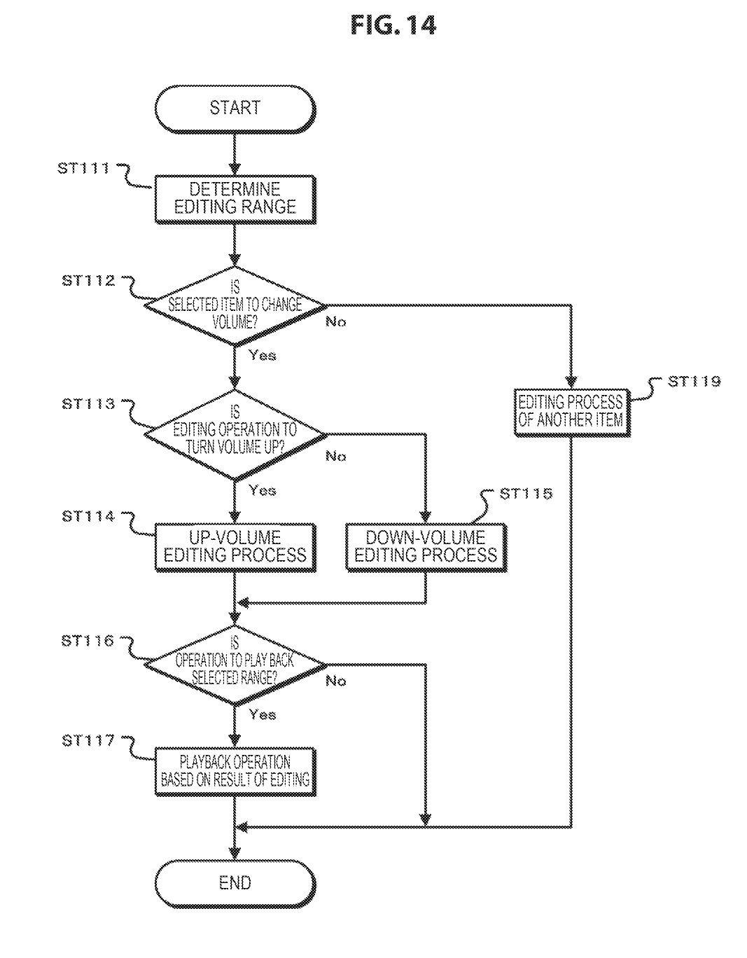

FIG. 14 is a flowchart illustrating an editing operation which is performed when the volume is changed in the information processing device 10. In step ST111, the information processing device 10 determines an editing range selected by the user's operation, and proceeds to step ST112.

In step ST112, the information processing device 10 determines whether or not the selected item is to change the volume. The information processing device 10, when an operation of selecting the item “volume” has been performed on the user interface unit 12, determines that the editing operation is to change the volume, and proceeds to step ST113. Also, the information processing device 10, when determining that an operation of selecting an item different from the item “volume” has been performed, determines that the editing operation is not to change the volume, and proceeds to step ST119.

In step ST113, the information processing device 10 determines whether or not the user's editing operation is to turn the volume up. The information processing device 10, when determining that an operation of turning the volume up has been performed on the user interface unit 12, proceeds to step ST114, and when determining that an operation of turning the volume down has been performed, proceeds to step ST115. For example, the information processing device 10 determines whether the operation of turning the volume up or the operation of decreasing volume has been performed on a spinner shown in the item “volume,” depending on which button has been operated.

In step ST114, the information processing device 10 performs an editing process of turning the volume up. The information processing device 10 changes an attribute indicating the volume to turn the volume up, and proceeds to step ST116. Also, in step ST115, the information processing device 10 performs a down-volume editing process. The information processing device 10 changes the attribute indicating the volume (e.g., a sound level attribute) to turn the volume down, and proceeds to step ST116. Moreover, the information processing device 10 may changes an attribute of characters, depending on the volume, thereby allowing for estimation of the volume based on a difference in the attribute. Note that the information processing device 10 adds a change corresponding to the editing operation to a content file, or stores a change corresponding to the editing operation in a difference information file.

In step ST116, the information processing device 10 determines whether or not the user's operation is to play back the selected range. If the user's operation performed after the operation of changing the volume is to select the item “play back selected range,” the information processing device 10 proceeds to step ST117. Otherwise, the information processing device 10 ends the editing operation of changing the volume.

In step ST117, the information processing device 10 performs a playback operation based on the result of the editing. Specifically, the information processing device 10 plays back the content after the editing process performed in step ST114 or step ST115, and ends the editing operation of changing the volume.

The information processing device 10, when proceeding from step ST112 to step ST119, performs an editing operation for another selected item.

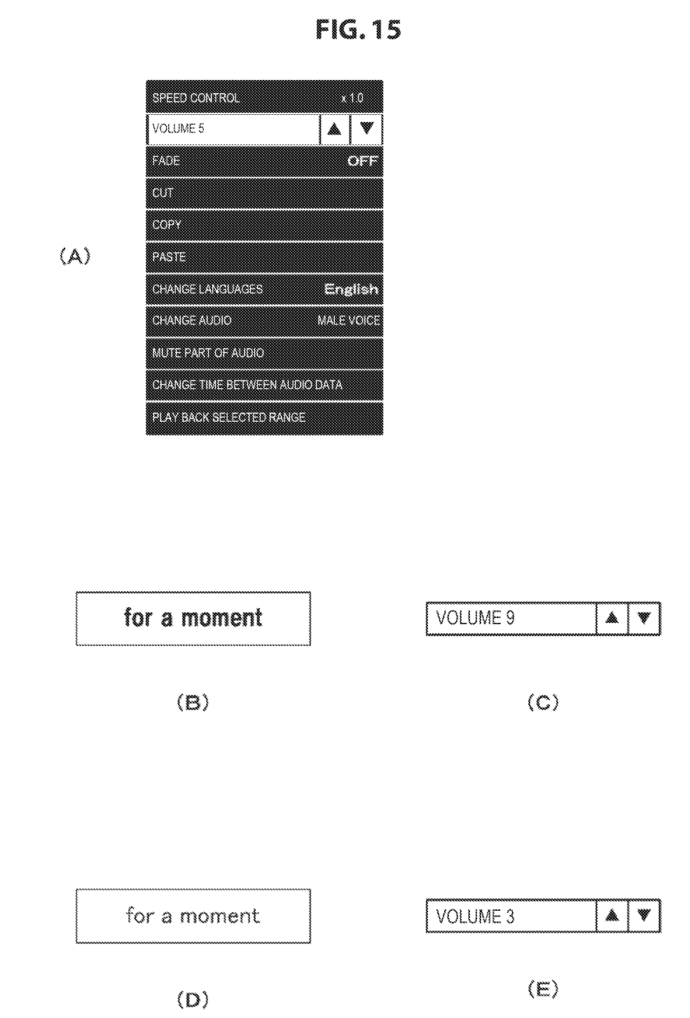

FIG. 15 illustrates an operation which is performed when the volume is changed. As shown in FIG. 15(A), the information processing device 10, when the item “volume” has been selected (in the figure, the selected item is indicated by reverse display), changes the volume, depending on the user's operation. The information processing device 10, when a button for turning the volume up has been operated, changes an attribute related to the volume to turn the volume up. Also, the information processing device 10 changes an attribute of characters corresponding to audio whose volume has been changed. For example, when the volume is increased, corresponding characters are thickened as shown in FIG. 15(B), and a volume level value displayed in the item “volume” is changed to a greater value as shown in FIG. 15(C). Also, the information processing device 10, when a button for turning the volume down has been operated, changes the attribute related to the volume to turn the volume up. Also, the information processing device 10 changes the attribute of characters corresponding to audio whose volume has been changed. For example, when the volume has been turned down, corresponding characters are narrowed as shown in FIG. 15(D), and the volume level value shown in the item “volume” is changed to a smaller value as shown in FIG. 15(E).

Therefore, by using the information processing device 10 of the present technology, the user can simply and easily change the volume of a desired portion.

[3-3. Fading Operation]

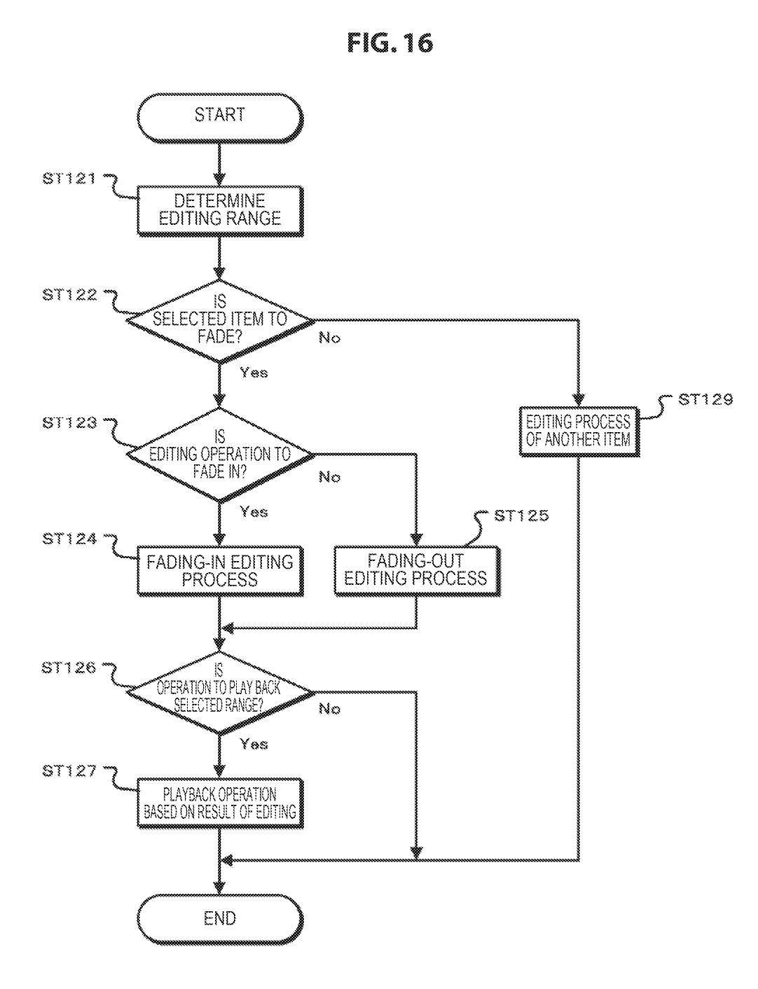

FIG. 16 is a flowchart illustrating an editing operation which is performed when fading is performed in the information processing device 10. In step ST121, the information processing device 10 determines an editing range selected by the user's operation, and proceeds to step ST122.

In step ST122, the information processing device 10 determines whether or not the selected item is a fading operation. The information processing device 10, when determining that an operation of selecting the item “fade” has been performed on the user interface unit 12, determines that the editing operation is a fading operation, and proceeds to step ST123. Also, the information processing device 10, when determining that an operation of selecting an item different from the item “fade” has been performed, determines that the editing operation is not a fading operation, and proceeds to step ST129.

In step ST123, the information processing device 10 determines whether or not the user's editing operation is a fading-in operation. The information processing device 10, when determining that a fading-in setting operation has been performed on the user interface unit 12, proceeds to step ST124, and when determining that a fading-out setting operation has been performed, proceeds to step ST125. For example, the information processing device 10 determines which of a fading-in setting button and a fading-out setting button shown in the item “fade” has been operated.

In step ST124, the information processing device 10 performs an editing process of fading in. For example, the information processing device 10 changes an attribute so that the volume is gradually turned up from the lowest level to a predetermined level, and proceeds to step ST126. Also, in step ST125, the information processing device 10 performs a fading-out editing process. For example, the information processing device 10 changes the attribute so that the volume is gradually turned down from a predetermined level to the lowest level, and proceeds to step ST126. Moreover, the information processing device 10 may change an attribute of characters, depending on the volume, thereby allowing for determination of a fading operation based on a difference in the attribute. Note that the information processing device 10 adds a change corresponding to the editing operation to a content file, or stores a change corresponding to the editing operation in a difference information file.

In step ST126, the information processing device 10 determines whether or not the user's operation is to play back the selected range. If the user's operation performed after the fading-in or fading-out setting operation is to select the item “play back selected range,” the information processing device 10 proceeds to step ST127. Otherwise, the information processing device 10 ends the editing operation involved in fading.

In step ST127, the information processing device 10 performs a playback operation based on the result of the editing. Specifically, the information processing device 10 plays back the content after the editing process performed in step ST124 or step ST125, and ends the editing operation involved in fading.

The information processing device 10, when proceeding from step ST122 to step ST129, performs an editing operation for another selected item.

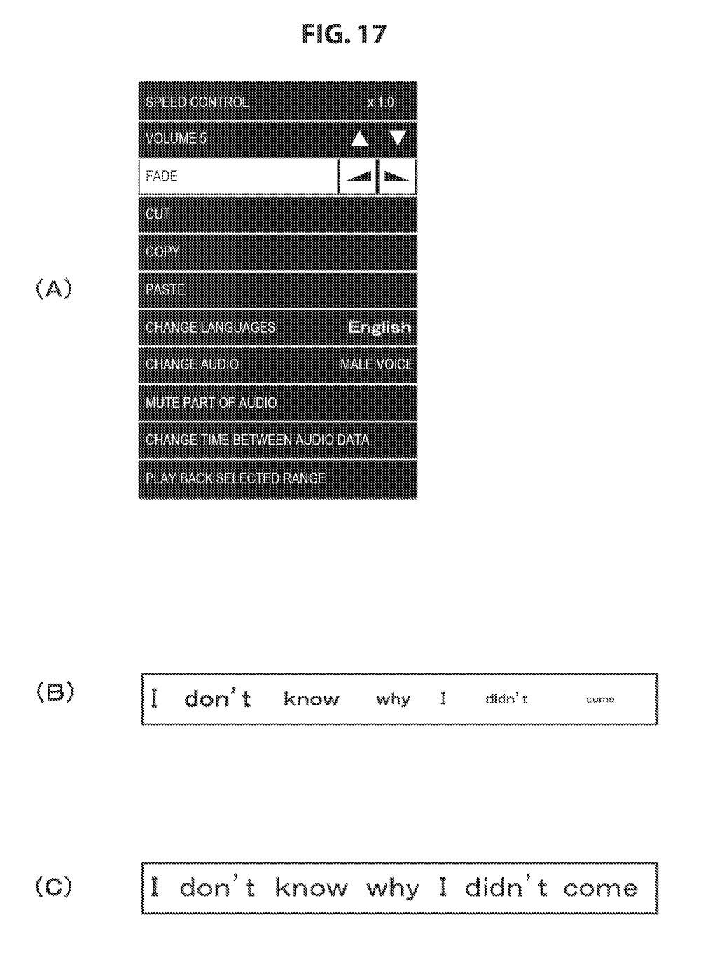

FIG. 17 illustrates an operation which is performed when fading is performed. As shown in FIG. 17(A), the information processing device 10, when the item “fade” has been selected (in the figure, the selected item is indicated by reverse display), sets fading, depending on the user's operation. For example, the information processing device 10, when a fading-out operation has been performed, changes the attribute related to the volume to gradually turn the volume up from a predetermined level to the lowest level, thereby performing the fading-out operation. Also, an attribute of characters corresponding to a part of audio which is to be faded out is changed. For example, as the volume is turned down by the fading-out operation, the size of corresponding characters is reduced as shown in FIG. 17(B). Note that FIG. 17(C) shows a display in a case where the fading-out operation has not been performed. Also, when an attribute of characters corresponding to audio for which a fading operation is performed is changed, the transmittance of characters may be changed in addition to the character size. For example, the character transmittance may be set to 0% at the beginning of fading-out, and the transmittance may be increased so that characters disappear as the volume is turned down.

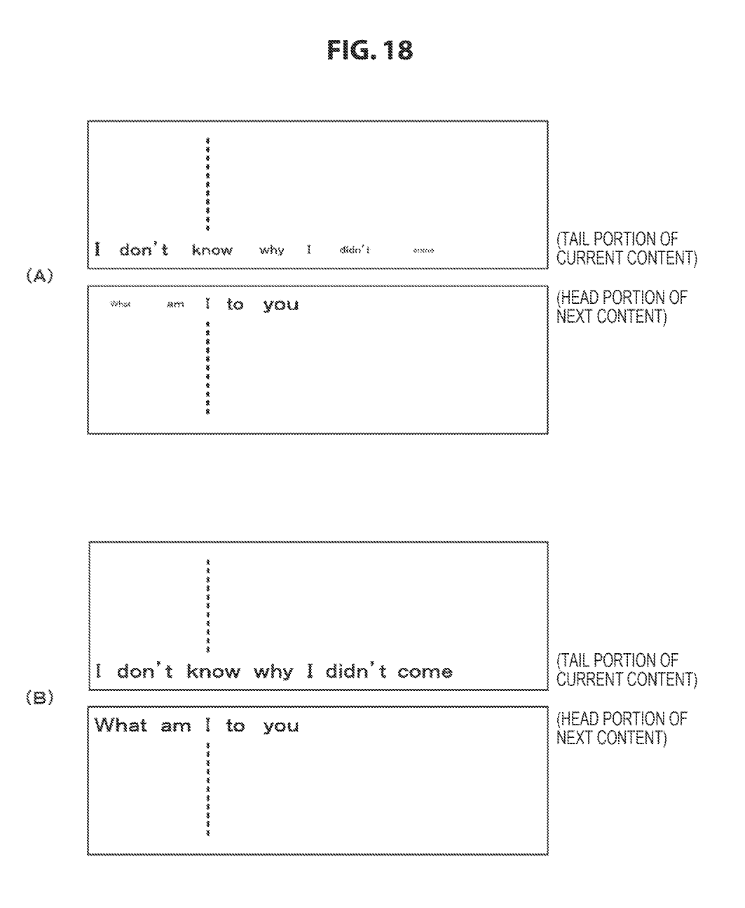

Moreover, if the fading-out operation is performed at a tail portion of content, and the fading-in operation is performed at a head portion of content which is next played back, multiple pieces of content can be smoothly changed when the pieces of content are successively played back. In this case, as shown in FIG. 18(A), of characters displayed on an image, the character size is gradually reduced to the minimum character size at a tail portion of current content, and the character size is gradually increased from the minimum size to a predetermined character size at a head portion of the next content. Note that FIG. 18(B) illustrates a case where the fading operation is not performed.

Therefore, by using the information processing device 10 of the present technology, the user can simply and easily set the fading operation to be performed at a desired portion.

[3-4. Copying, Pasting, and Cutting Operations]

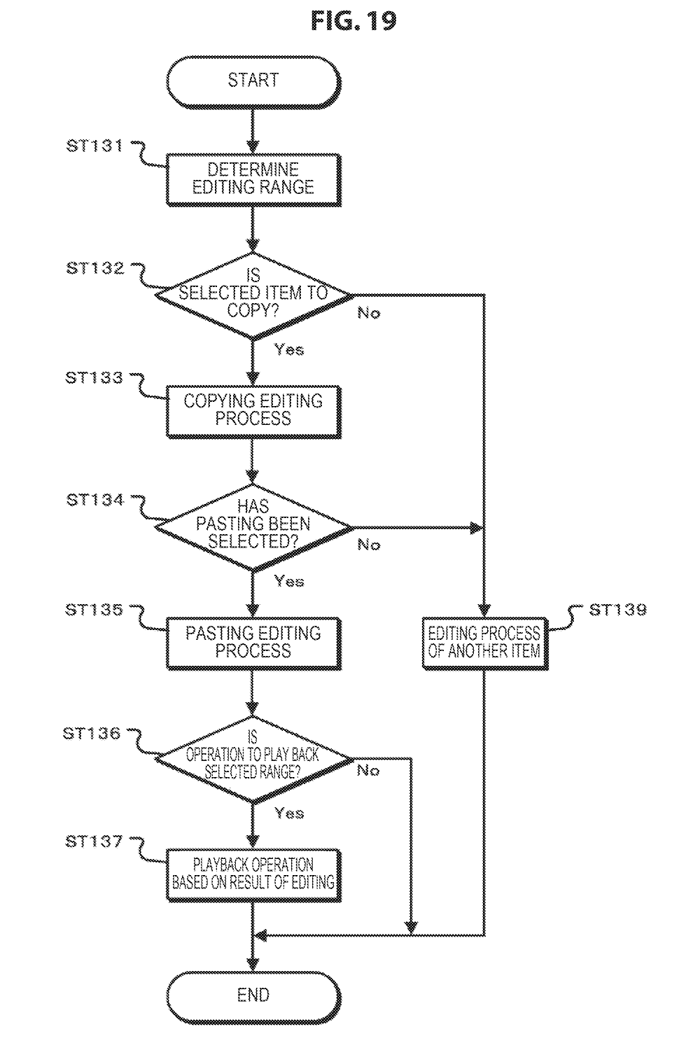

FIG. 19 is a flowchart illustrating an editing operation which is performed when copying and pasting are performed in the information processing device 10. In step ST131, the information processing device 10 determines an editing range selected by the user's operation, and proceeds to step ST132.

In step ST132, the information processing device 10 determines whether or not the selected item is a copying operation. The information processing device 10, when determining that an operation of selecting the item “copy” has been performed on the user interface unit 12, determines that the editing operation is a copying operation, and proceeds to step ST133. Also, the information processing device 10, when determining that an operation of selecting an item different from the item “copy” has been performed, determines that the editing operation is not a copying operation, and proceeds to step ST139.

In step ST133, the information processing device 10 performs a copying editing process. The information processing device 10 obtains and stores content in the selected range and an attribute related to the content into a buffer, etc., and proceeds to step ST134.

In step ST134, the information processing device 10 determines whether or not the user's operation is to paste. If the user's operation performed after the operation of selecting copying is to select the item “paste,” the information processing device 10 determines that the editing operation is to paste, and proceeds to step ST135. Also, the information processing device 10, when determining that an operation of selecting an item different from the item “paste” has been performed, determines that the editing operation is not to paste, and proceeds to step ST139.

In step ST135, the information processing device 10 performs an editing process of pasting. The information processing device 10 determines a paste destination specified by the user, and inserts the content selected by the above copying operation at the determined paste destination. Also, the information processing device 10 performs an attribute editing process corresponding to the insertion of the content using an attribute related to the inserted content, and proceeds to step ST136. Note that the information processing device 10 adds a change corresponding to the editing operation to a content file, or stores a change corresponding to the editing operation in a difference information file.

In step ST136, the information processing device 10 determines whether or not the user's operation is to play back the selected range. If the user's operation performed after the copying and pasting setting operation is to select the item “play back selected range,” the information processing device 10 proceeds to step ST137. Otherwise, the information processing device 10 ends the editing operation involved in copying and pasting.

In step ST137, the information processing device 10 performs a playback operation based on the result of the editing. Specifically, the information processing device 10 plays back the content after the editing process performed in step ST135, and ends the editing operation involved in copying and pasting.

The information processing device 10, when proceeding from step ST132 or S134 to step ST139, performs an editing operation for another selected item.

Note that when the item “cut” has been selected, an editing process is performed for deleting the content in the selected range and the attribute of the content or excluding the content from those which are to be played back.

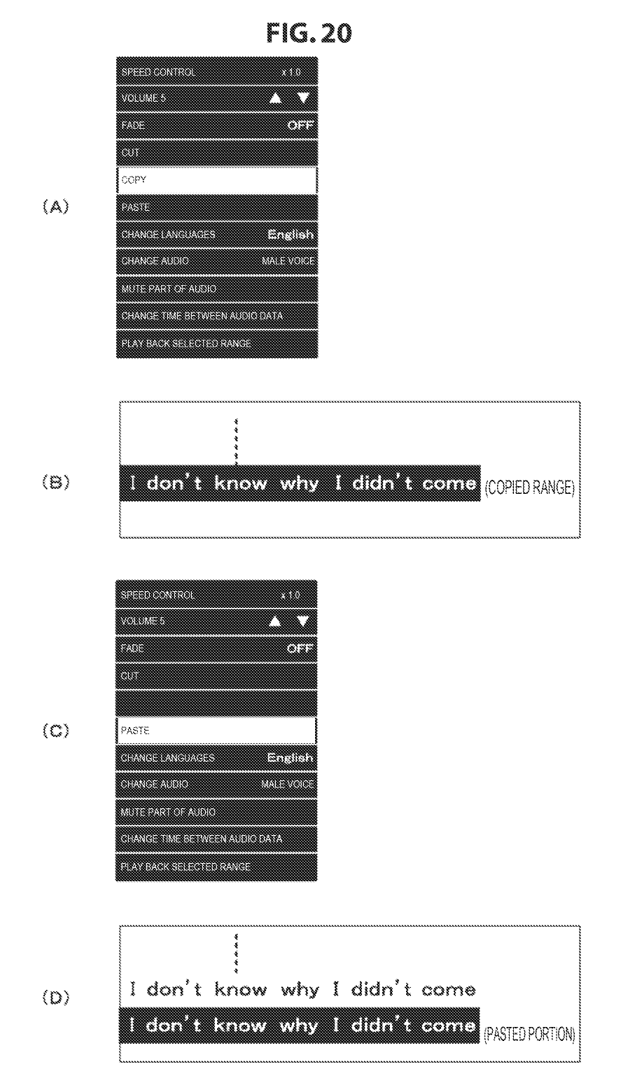

FIG. 20 illustrates an operation which is performed when copying and pasting are performed. The information processing device 10, when the item “copy” has been selected as shown in FIG. 20(A) (in the figure, the selected item is indicated by reverse display), obtains and stores content in a selected range and an attribute of the content into a buffer, etc., as shown in FIG. 20(B). Thereafter, as shown in FIG. 20(C), the information processing device 10, when the item “paste” has been selected (in the figure, the selected item is indicated by reverse display), inserts the content selected by the copying operation at a location of the paste destination. Also, the information processing device 10 performs an attribute editing process corresponding to the insertion of the content using an attribute related to the inserted content.

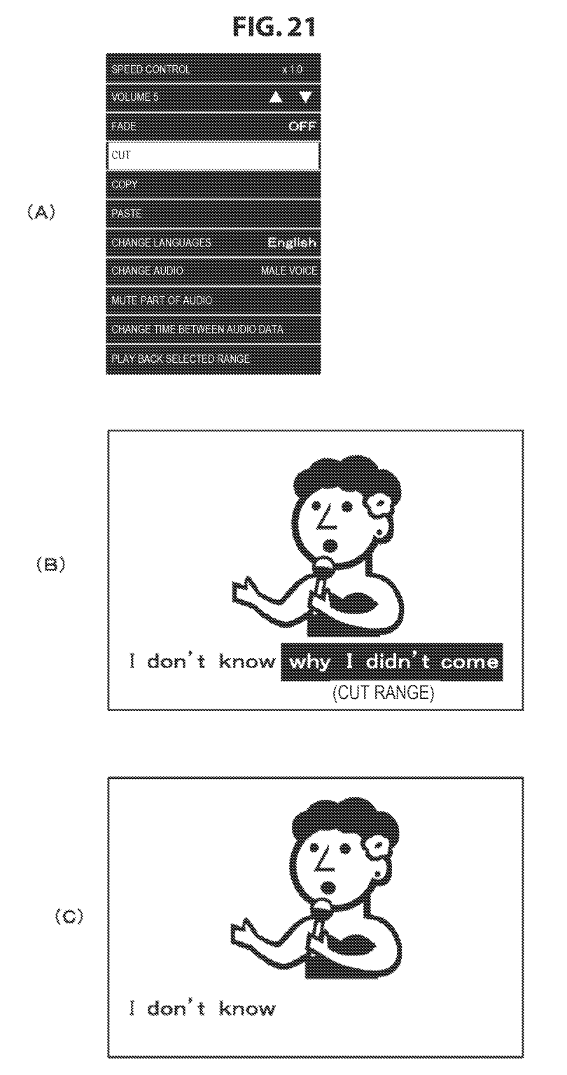

FIG. 21 illustrates an operation which is performed when cutting is performed. The information processing device 10, when the item “cut” has been selected as shown in FIG. 21(A) (in the figure, the selected item is indicated by reverse display), performs an editing process to delete content (characters and audio) in a cutting range shown in FIG. 21(B) and an attribute of the content, or exclude the content from those which are to be played back. Also, when a moving image is played back in association with the content (characters and audio) in the selected range, the information processing device 10 deletes or excludes a moving image portion corresponding to the content in the selected range from those which are to be played back, in the editing process. Therefore, in a playback operation after cutting, a portion “‘why I didn’t come” is not displayed, and a moving image corresponding to the portion “why I didn't come” is not played back, as shown in FIG. 21(C).

Therefore, by using the information processing device 10 of the present technology, the user can simply and easily perform copying, pasting, and cutting.

[3-5. Changing Languages]

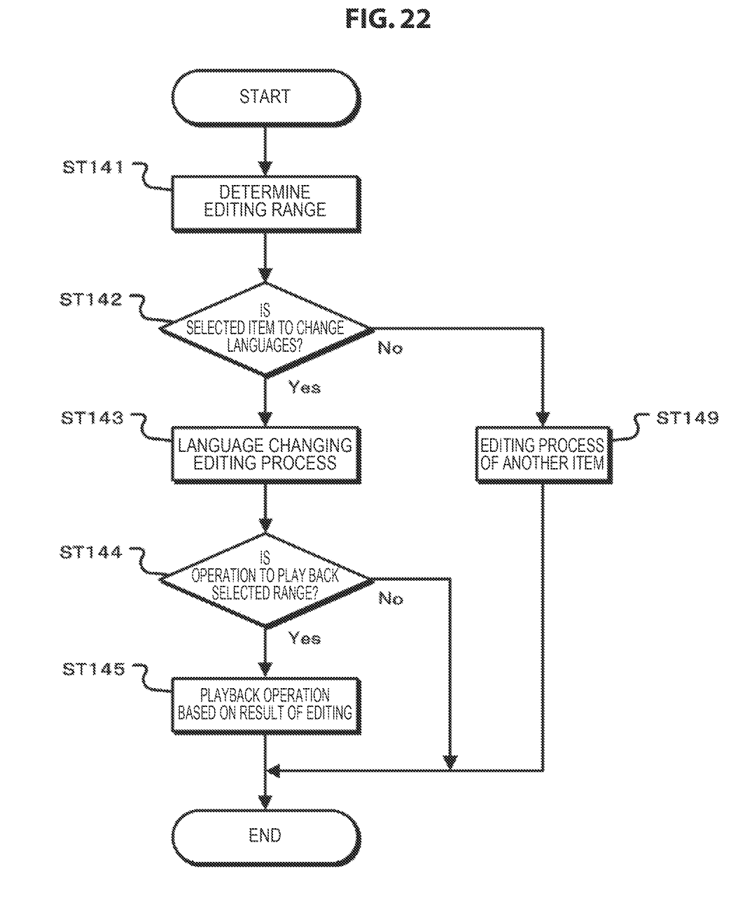

FIG. 22 is a flowchart illustrating an editing operation which is performed when languages are changed in the information processing device 10. In step ST141, the information processing device 10 determines an editing range selected by the user's operation, and proceeds to step ST142.

In step ST142, the information processing device 10 determines whether or not the selected item is to change languages. The information processing device 10, when determining that an operation of selecting the item “change languages” has been performed on the user interface unit 12, determines that the editing operation is to change languages, and proceeds to step ST143. Also, the information processing device 10, when determining that an operation of selecting an item different from the item “change languages” has been performed, determines that the editing operation is not to change languages, and proceeds to step ST149.

In step ST143, the information processing device 10 performs an editing process of changing languages. The information processing device 10 performs the editing process so that audio data in a selected language is used for an attribute related to audio, and proceeds to step ST144. Note that the information processing device 10 adds a change corresponding to the editing operation to a content file, or stores a change corresponding to the editing operation in a difference information file.

In step ST144, the information processing device 10 determines whether or not the user's operation is to play back the selected range. If the user's operation performed after the language changing operation is to select the item “play back selected range,” the information processing device 10 proceeds to step ST145. Otherwise, the information processing device 10 ends the editing operation involved in changing languages.

In step ST145, the information processing device 10 performs a playback operation based on the result of the editing. Specifically, the information processing device 10 plays back the content after the editing process performed in step ST143, and ends the editing operation involved in changing languages.

The information processing device 10, when proceeding from step S142 to step ST149, performs an editing operation for another selected item.

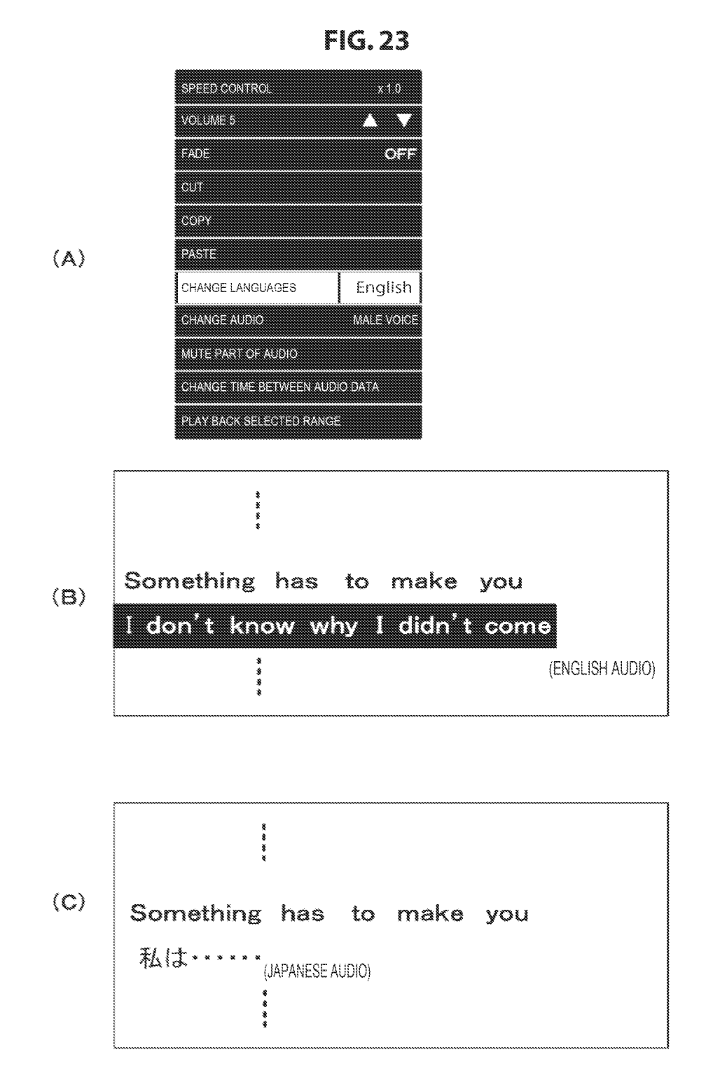

FIG. 23 illustrates an operation which is performed when languages are changed. The information processing device 10, when the item “change languages” has been selected as shown in FIG. 23(A) (in the figure, the selected item is indicated by reverse display), changes languages, depending on the user's operation. Note that changing languages may, for example, be achieved by displaying a list box, etc., indicating selectable languages and thereby allowing the user to select a desired one from the displayed languages.

For example, when the Japanese language has been selected for an editing range (a character portion in reverse display) shown in FIG. 23(B), the information processing device 10 performs an editing process of setting the language or audio of content to the selected language, and during playback, outputs Japanese display and Japanese audio as shown in FIG. 23(C).

Therefore, by using the information processing device 10 of the present technology, the user can simply and easily play back content in a desired language.

[3-6. Changing Speech]

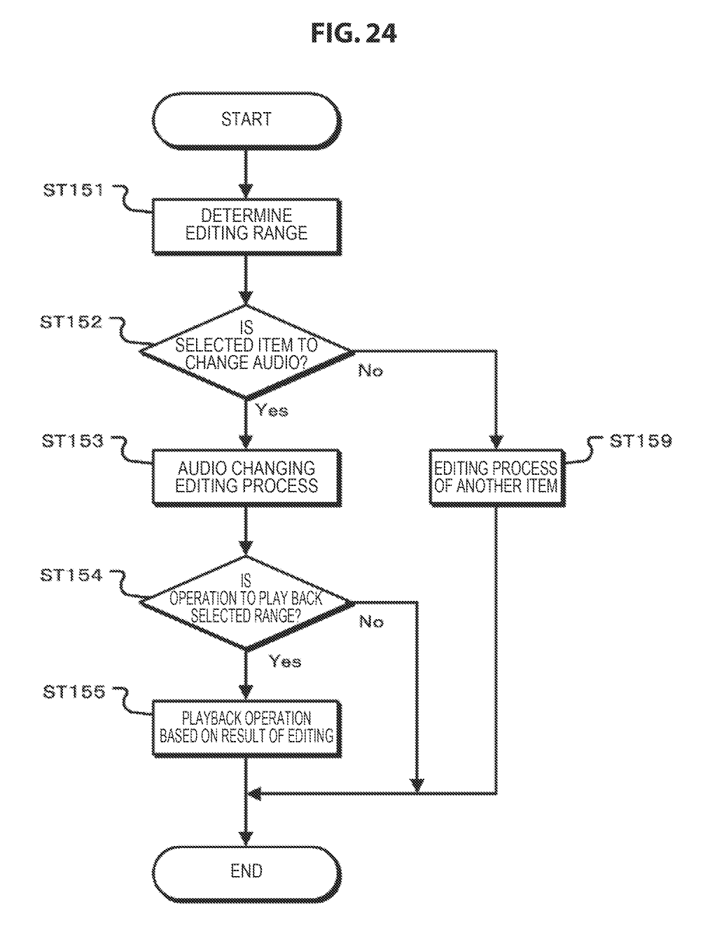

FIG. 24 is a flowchart illustrating an editing operation which is performed when audio is changed in the information processing device 10. In step ST151, the information processing device 10 determines an editing range selected by the user's operation, and proceeds to step ST152.

In step ST152, the information processing device 10 determines whether or not the selected item is to change audio. The information processing device 10, when determining that an operation of selecting the item “change audio” has been performed on the user interface unit 12, determines that the editing operation is to change audio, and proceeds to step ST153. Also, the information processing device 10, when determining that an operation of selecting an item different from the item “change audio” has been performed, determines that the editing operation is not to change audio, and proceeds to step ST159.

In step ST153, the information processing device 10 performs an editing process of changing audio. The information processing device 10 performs the editing process so that selected audio data is used for an attribute related to audio, and proceeds to step ST154. Note that the information processing device 10 adds a change corresponding to the editing operation to a content file, or stores a change corresponding to the editing operation in a difference information file.

In step ST154, the information processing device 10 determines whether or not the user's operation is to play back the selected range. If the user's operation performed after the audio changing operation is to select the item “play back selected range,” the information processing device 10 proceeds to step ST155. Otherwise, the information processing device 10 ends the editing operation involved in changing audio.

In step ST155, the information processing device 10 performs a playback operation based on the result of the editing. Specifically, the information processing device 10 plays back the content after the editing process performed in step ST153, and ends the editing operation involved in changing audio.

The information processing device 10, when proceeding from step ST152 to step ST159, performs an editing operation for another selected item.

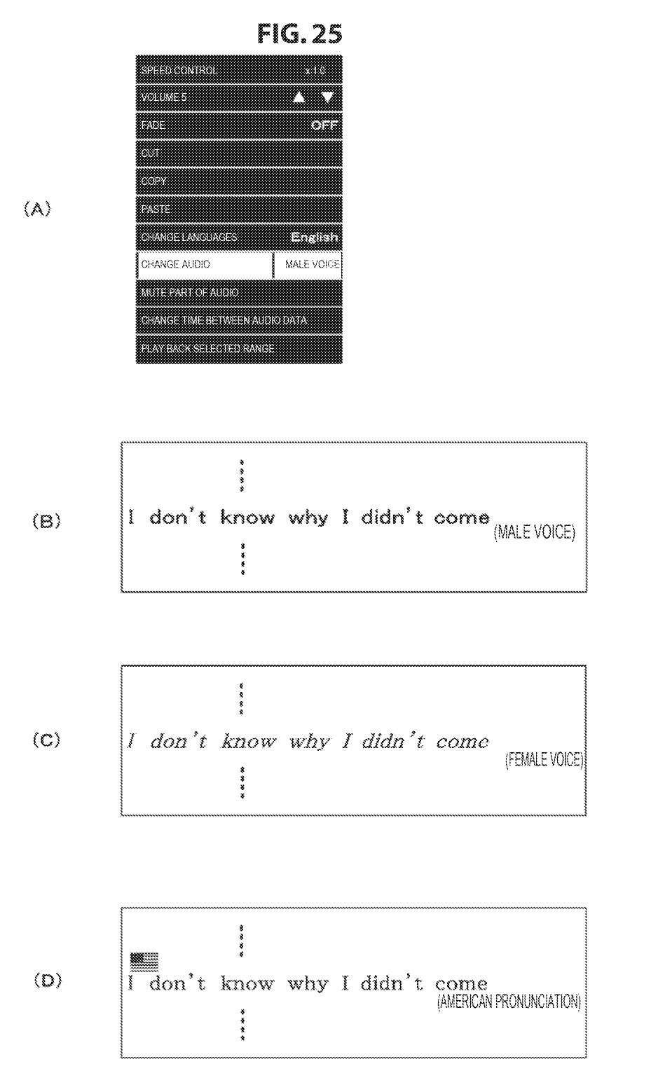

FIG. 25 illustrates an operation which is performed when audio is changed. The information processing device 10, when the item “change audio” has been selected as shown in FIG. 25(A) (in the figure, the selected item is indicated by reverse display), changes audio, depending on the user's operation. Note that changing audio may, for example, be achieved by displaying a list box, etc., indicating selectable audio types and thereby allowing the user to select a desired audio type from the displayed audio types. Also, audio may be changed, depending on an attribute of displayed content. For example, audio may be changed so that audio corresponding to the type of a character font is used.

For example, when a female voice is selected for the editing range of FIG. 25(B), the information processing device 10 performs an editing process to change an attribute of audio for the editing range and thereby providing audio of the female voice, and during playback, outputs female audio as shown in FIG. 25(C). Also, the information processing device 10 may change an attribute related to display, depending on changing of audio. For example, the information processing device 10 may change character fonts in connection with changing of audio so that a portion in which changing audio is performed can be visually recognized. Also, audio may be changed, depending on the character font type. Also, in changing audio, different pronunciations may be changed. For example, changing audio may be performed on content having British pronunciation so that audio can be output in American pronunciation as shown in FIG. 25(D). Note that the figure illustrates a case where an icon (the national flag of the United States of America) is displayed for indicating American pronunciation in an identifiable manner.

Therefore, by using the information processing device 10 of the present technology, the user can simply and easily play back content using desired audio.

[3-7. Operation of Muting Part of Speech]

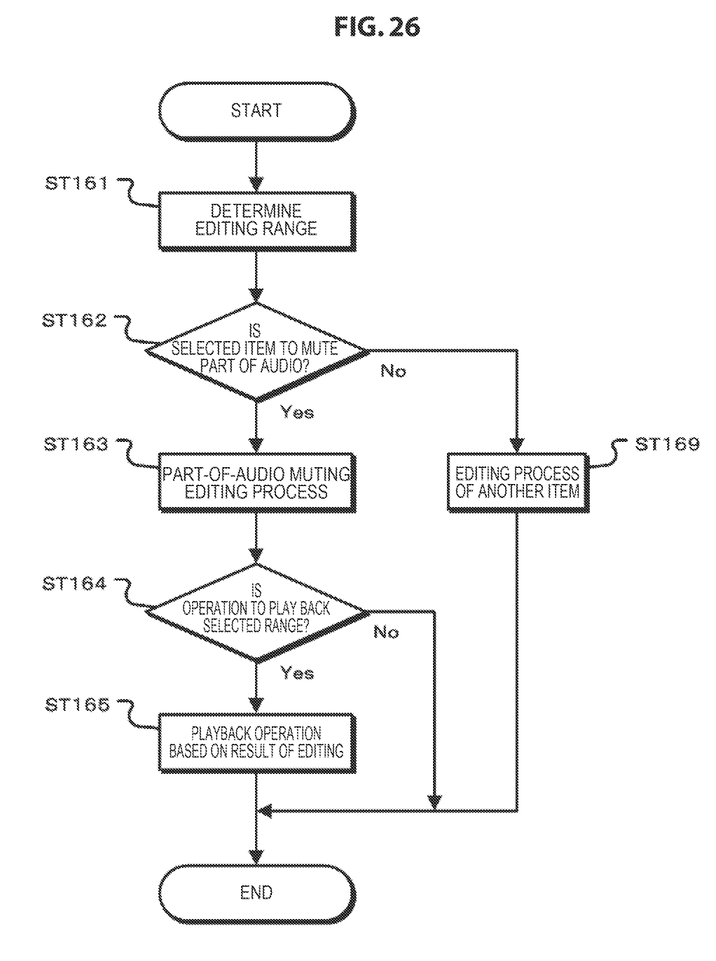

FIG. 26 is a flowchart illustrating an editing operation which is performed when audio is muted in the information processing device 10. In step ST161, the information processing device 10 determines an editing range selected by the user's operation, and proceeds to step ST162.

In step ST162, the information processing device 10 determines whether or not the selected item is to mute a part of audio. The information processing device 10, when determining that an operation of selecting the item “mute part of audio” has been performed on the user interface unit 12, determines that the editing operation is to mute audio, and proceeds to step ST163. Also, the information processing device 10, when determining that an operation of selecting an item different from the item “mute part of audio” has been performed, determines that the editing operation is not to mute audio, and proceeds to step ST169.

In step ST163, the information processing device 10 performs an editing process of muting a part of audio. The information processing device 10 performs an editing process on an attribute related to audio so that audio corresponding to the selected range is not to be played back, and proceeds to step ST164. Also, the information processing device 10 may change an attribute so that characters in the range for which the muting operation has been performed are not to be displayed. Note that the information processing device 10 adds a change corresponding to the editing operation to a content file, or stores a change corresponding to the editing operation in a difference information file.

In step ST164, the information processing device 10 determines whether or not the user's operation is to play back the selected range. If the user's operation performed after the operation of changing languages is to select the item “play back selected range,” the information processing device 10 proceeds to step ST165. Otherwise, the information processing device 10 ends the editing operation involved in muting a part of audio.

In step ST165, the information processing device 10 performs a playback operation based on the result of the editing. Specifically, the information processing device 10 plays back the content after the editing process performed in step ST163, and ends the editing operation involved in muting a part of audio.

The information processing device 10, when proceeding from step ST162 to step ST169, performs an editing operation for another selected item.

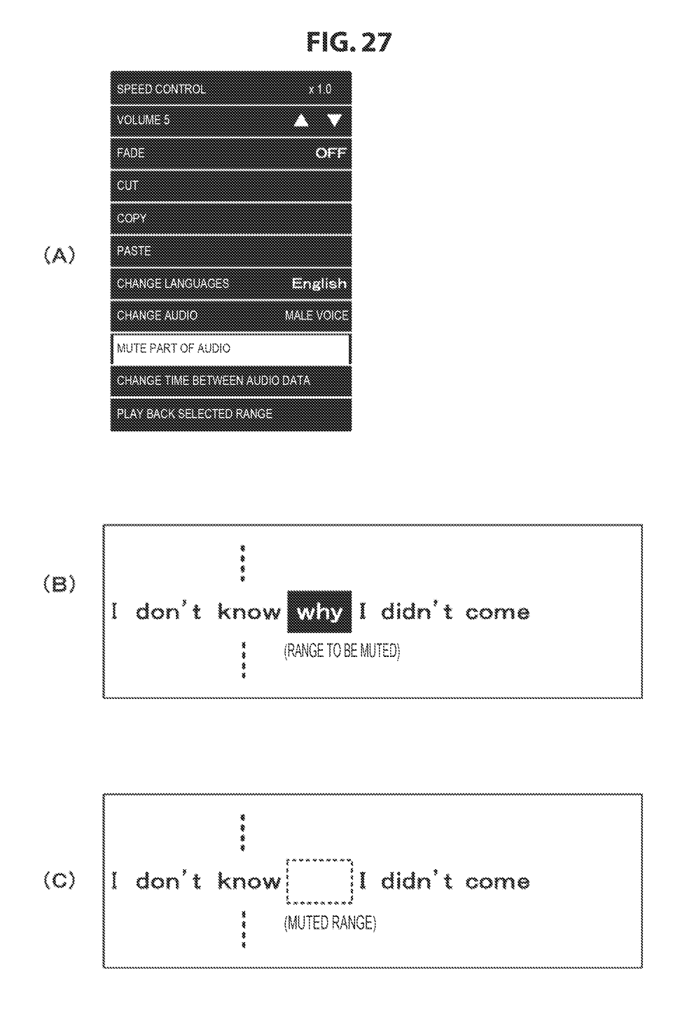

FIG. 27 illustrates an operation which is performed when a part of audio is muted. The information processing device 10, when the item “mute part of audio” has been selected as shown in FIG. 27(A) (in the figure, the selected item is indicated by reverse display), mutes audio, depending on the user's operation.

When the muting operation is performed on an editing range shown in FIG. 27(B), the information processing device 10 performs playback while muting audio in the editing range as shown in FIG. 27(C). Also, if characters are not displayed in the set range in which audio is muted, only audio corresponding to the displayed characters can be output. Thus, the information processing device 10 cancels playback of content in an editing range.

Therefore, by using the information processing device 10 of the present technology, the user can simply and easily set a desired portion to a muting operation.

[3-8. Changing Time Between Speech Data]

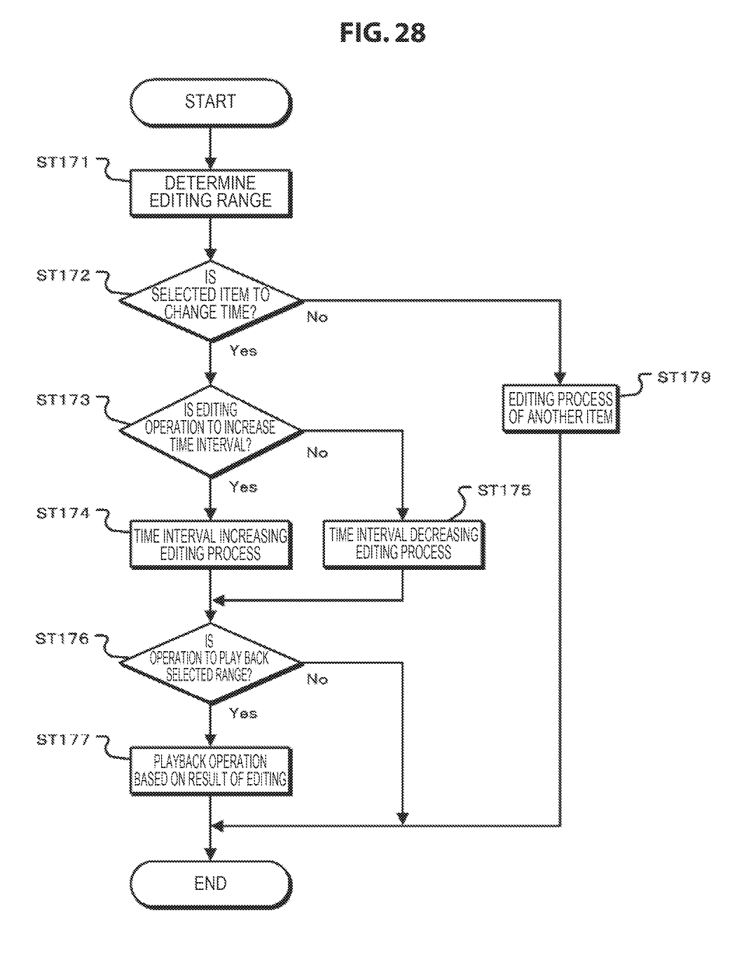

FIG. 28 is a flowchart illustrating an editing operation which is performed when a time between audio data is changed in the information processing device 10. In step ST171, the information processing device 10 determines an editing range selected by the user's operation, and proceeds to step ST172.

In step ST172, the information processing device 10 determines whether or not the selected item is to change the time between audio data. The information processing device 10, when determining that an operation of selecting the item “change time between audio data” has been performed on the user interface unit 12, determines that the editing operation is to change the time between audio data, and proceeds to step ST173. Also, the information processing device 10, when determining that an operation of selecting an item different from the item “change time between audio data” has been performed, determines that the editing operation is not to change the time between audio data, and proceeds to step ST179.

In step ST173, the information processing device 10 determines whether or not the user's editing operation is to increase the time interval. The information processing device 10, when determining that an operation of increasing the time interval has been performed on the user interface unit 12, proceeds to step ST174, and when determining that an operation of decreasing the time interval has been performed, proceeds to step ST175. For example, the information processing device 10 determines that an operation of increasing the time interval has been performed if a pinch-open operation has been performed on the user interface unit 12, and determines that an operation of decreasing the time interval has been performed if a pinch-close operation has been performed. Also, the information processing device 10 may display a spinner, and perform the operation of increasing or decreasing the time interval, depending on the user's operation performed on the spinner.

In step ST174, the information processing device 10 performs an editing process of increasing the time interval. The information processing device 10 changes an attribute indicating a location where audio data is to be played back, to increase the time interval, and proceeds to step ST176. Also, in step ST175, the information processing device 10 performs an editing process of decreasing the time interval. The information processing device 10 changes an attribute indicating a location where audio data is to be played back, to decrease the time interval, and proceeds to step ST176. Note that the information processing device 10 adds a change corresponding to the editing operation to a content file, or stores a change corresponding to the editing operation in a difference information file.

In step ST176, the information processing device 10 determines whether or not the user's operation is to play back the selected range. If the user's operation performed after the operation of changing the time between audio data is to select the item “play back selected range,” the information processing device 10 proceeds to step ST177. Otherwise, the information processing device 10 ends the editing operation involved in changing the time between audio data.

In step ST177, the information processing device 10 performs a playback operation based on the result of the editing. Specifically, the information processing device 10 plays back the content after the editing process performed in step ST174 or step ST175, and ends the editing operation involved in changing the time between audio data.

The information processing device 10, when proceeding from step ST172 to step ST179, performs an editing operation for another selected item.

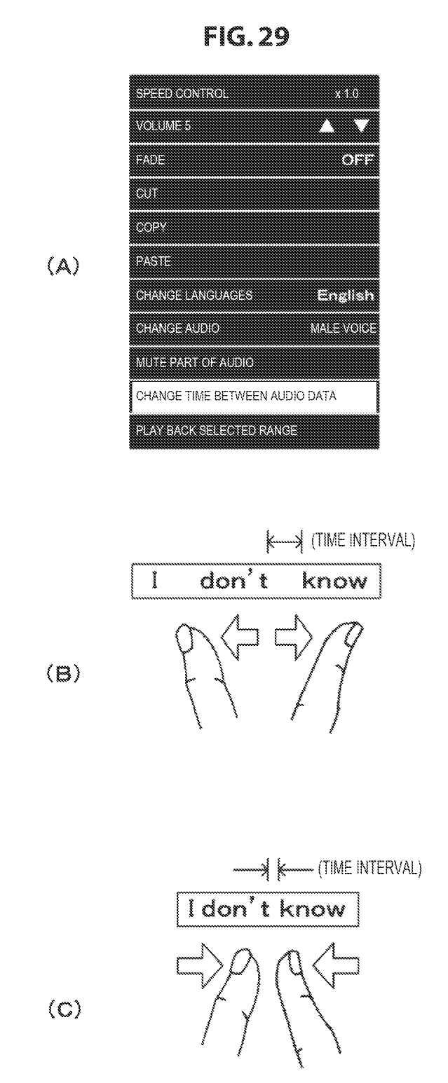

FIG. 29 illustrates the operation of changing the time of audio data. As shown in FIG. 29(A), the information processing device 10, when the item “change time between audio data” has been selected (in the figure, the selected item is indicated by reverse display), changes the time interval, depending on the user's operation. For example, the information processing device 10, when a pinch-open operation has been performed in the editing range as shown in FIG. 29(B), change an attribute related to playback of audio data to increase the time interval between audio data. Also, the information processing device 10 changes an attribute related to character display, etc., depending on the increased time interval, thereby displaying words with increased spacing. The information processing device 10, when a pinch-close operation has been performed in the editing range as shown in FIG. 29(C), changes the attribute related to playback of audio data to decrease the time interval between audio data. Also, the information processing device 10 changes the attribute related to character display, etc., depending on the decreased time interval, thereby displaying words with decreased spacing.

Also, for example, the information processing device 10 may change the time interval only at a location between words indicated by the user in addition to a case where the time interval between audio data corresponding to content in the selected range is changed.

Therefore, by using the information processing device 10 of the present technology, the user can simply and easily change the time interval between audio data at a desired portion.

Also, the various processes described herein may be implemented with hardware or software or with a combination of both. When a process implemented with software is performed, a program recording a process sequence is installed in a memory in a computer incorporated in dedicated hardware, and is executed. Alternatively, a program may be installed in a general-purpose computer which can perform various processes, and may be executed.

For example, a program may be previously recorded in a hard disk or a ROM (Read Only Memory) as a recording medium. Alternatively, a program may be temporarily or permanently stored (recorded) in a removable recording medium, such as a flexible disk, optical disk, magneto-optical disk, magnetic disk, semiconductor memory card, etc. Such a removable recording medium may be provided as a so-called software package.

Also, a program may be transferred to a computer through a network, such as a LAN (Local Area Network), the Internet, etc., from a download site, wirelessly or through a wired connection, in addition to installing to a computer from a removable recording medium. The computer can receive the program thus transferred, and install the program to a recording medium, such as an internal hard disk, etc.

Note that the present technology is in no way meant to be limited to the above embodiments of the present technology. The embodiments of the present technology are merely illustrative. It is obvious that modifications and substitutions can be made to the embodiments by those skilled in the art without departing from the scope of the present technology. The scope of the present technology should be determined with reference to the claims.

Additionally, the information processing device according to the present technology can also be configured as below.

(1)

An information processing device including:

a user interface unit which receives a user's operation;

a playback control unit which performs an editing process on content playback control information, depending on the user's operation received by the user interface unit, and controls an operation of playing back content based on the content playback control information; and

a display unit which displays a played-back image of the content.

(2)

The information processing device according to (1), wherein

the content contains a display content and an audio content associated with the display content.

(3)

The information processing device according to (2), wherein

the content playback control information includes an attribute of the content, and

the playback control unit changes the attribute in the editing process to change the operation of playing back the content to a playback operation depending on the user's operation.

(4)

The information processing device according to (3), wherein

the playback control unit performs an editing process of changing an attribute of the display content in connection with a change in an operation of playing back the audio content, and changing an operation of playing back the audio content in connection with a change in the attribute of the display content.

(5)

The information processing device according to any of (2) to (4), wherein

the playback control unit performs an editing process of changing playback speed of content in an editing range on the content playback control information.

(6)

The information processing device according to any of (2) to (5), wherein

the playback control unit performs an editing process of changing volume of audio content in an editing range on the content playback control information.

(7)

The information processing device according to any of (2) to (6), wherein

the playback control unit performs an editing process of performing an operating of fading audio content in an editing range on the content playback control information.

(8)

The information processing device according to any of (2) to (7), wherein

the playback control unit performs an editing process of changing a language of content in an editing range on the content playback control information.

(9)

The information processing device according to any of (2) to (8), wherein

the playback control unit performs an editing process of changing audio in an editing range on the content playback control information.

(10)

The information processing device according to any of (2) to (9), wherein

the playback control unit performs an editing process of cancelling playback of content in an editing range on the content playback control information.

(11)

The information processing device according to any of (2) to (10), wherein

the playback control unit performs an editing process of changing a time between audio data in audio content on the content playback control information.

(12)

The information processing device according to any of (2) to (11), wherein

the playback control unit performs an editing process of performing an operation of copying or cutting content in an editing range on the content playback control information.

(13)

The information processing device according to any of (2) to (12), wherein

the playback control unit performs an editing process of performing a pasting operation of inserting content at a specified location on the content playback control information.

(14)

The information processing device according to (1), wherein

the playback control unit generates difference information indicating detail of the editing process.

### INDUSTRIAL APPLICABILITY

In the information processing device, information processing method, and program of the present technology, an editing process is performed on content playback control information, depending on the user's operation which has been received. A content playback operation is controlled based on the content playback control information so that a played-back image of content is displayed on a display unit. Therefore, for example, when an operation of playing back content in which display content is associated with audio content is adjusted, the playback operations of the display content and the audio content can be adjusted together without performing an editing process on each piece of content separately. Therefore, the content playback operation can be easily adjusted. Therefore, the present technology is suitable for electronic devices, such as a mobile terminal device which plays back display content, such as a moving image, text, etc., and audio content corresponding to the display content, such as lines of dialogue, read-aloud audio, etc.

### REFERENCE SIGNS LIST

10 information processing device
11 display unit
12 user interface unit
20 playback control unit
21 control process unit
22 playback engine
23 rendering engine
31 media player

1. An information processing device comprising:
a user interface unit which receives a user's operation;
a playback control unit which performs an editing process on content playback control information, depending on the user's operation received by the user interface unit, and controls an operation of playing back content based on the content playback control information; and
a display unit which displays a played-back image of the content.

2. The information processing device according to claim 1, wherein
the content contains a display content and an audio content associated with the display content.

3. The information processing device according to claim 2, wherein
the content playback control information includes an attribute of the content, and
the playback control unit changes the attribute in the editing process to change the operation of playing back the content to a playback operation depending on the user's operation.

4. The information processing device according to claim 3, wherein
the playback control unit performs an editing process of changing an attribute of the display content in connection with a change in an operation of playing back the audio content, and changing an operation of playing back the audio content in connection with a change in the attribute of the display content.

5. The information processing device according to claim 2, wherein
the playback control unit performs an editing process of changing playback speed of content in an editing range on the content playback control information.

6. The information processing device according to claim 2, wherein
the playback control unit performs an editing process of changing volume of audio content in an editing range on the content playback control information.

7. The information processing device according to claim 2, wherein
the playback control unit performs an editing process of performing an operating of fading audio content in an editing range on the content playback control information.

8. The information processing device according to claim 2, wherein
the playback control unit performs an editing process of changing a language of content in an editing range on the content playback control information.

9. The information processing device according to claim 2, wherein
the playback control unit performs an editing process of changing audio in an editing range on the content playback control information.

10. The information processing device according to claim 2, wherein
the playback control unit performs an editing process of cancelling playback of content in an editing range on the content playback control information.

11. The information processing device according to claim 2, wherein
the playback control unit performs an editing process of changing a time between audio data in audio content on the content playback control information.

12. The information processing device according to claim 2, wherein
the playback control unit performs an editing process of performing an operation of copying or cutting content in an editing range on the content playback control information.

13. The information processing device according to claim 2, wherein
the playback control unit performs an editing process of performing a pasting operation of inserting content at a specified location on the content playback control information.

14. The information processing device according to claim 1, wherein
the playback control unit generates difference information indicating detail of the editing process.

15. An information processing method comprising the steps of:
receiving a user's operation;
performing an editing process on content playback control information, depending on the user's operation, and
controlling an operation of playing back content based on the content playback control information.

16. A program for causing a computer to control playback of content, the program causing the computer to execute the procedures of:
receiving a user's operation;
performing the editing process on content playback control information, depending on the user's operation; and
controlling playback of content based on the content playback control information.
